(19) United States
(12) Patent Application Publication
(10) Pub. No.: US 2002/0194361 A1
(43) Pub. Date: Dec. 19, 2002

(54) Data transmitting/receiving method, transmitting device, receiving device, transmiting/receiving system, and program

(76) Inventors: Tomoaki Itoh, Osaka (JP); Takao Yamaguchi, Kyoto (JP); Junichi Sato, Nara (JP); Hiroshi Arakawa, Kyoto (JP)

Correspondence Address: HARNESS, DICKEY & PIERCE, P.L.C., P.O. BOX 828, BLOOMFIELD HILLS, MI, 48303, US

(21) Appl. No.: 10/168,260

(22) PCT Filed: Aug. 10, 2001
(86) PCT No.: PCT/JP01/06959

(30) Foreign Application Priority Data
Sep. 22, 2000 (JP) 200-288348
Dec. 8, 2000 (JP) 2000-374857
Feb. 26, 2001 (JP) 2001-51037

(51) Int. Cl. G06F 15/16

(52) U.S. Cl. 709/233; 709/224

(57) ABSTRACT

In a sending terminal (10), a propagation delay measurement portion (102) uses propagation delay time measurement packets to measure the round trip time to/from an intermediate node of intermediate nodes (12, 13, 14) with the potential of becoming a bottleneck. Based on the results of this measurement, a transmission rate determining portion (104) determines the transmission rate of the data, and a data sending portion (100) sends the data at the determined transmission rate.

### TECHNICAL FIELD

The present invention relates to a data sending/receiving method, a sending device, a receiving device, a sending/receiving system, and a program for the sending and receiving of data using the Internet, for example, in an environment with a combination of wired and wireless sections and very large variations in bandwidth.

### BACKGROUND ART

In IP (Internet Protocol) networks, such as intranets and the Internet, there are large differences in the usable bandwidth, ranging from several Kbps to several hundred Mbps, depending the connection scheme. Moreover, the effect of other flows can cause temporal variations in the usable bandwidth. To provide stable communications quality over these networks, the largest value of the transmission bandwidth securable over the communications route must be estimated (this is known as “bandwidth estimate”) and the transmission rate of data from the sending terminal must be changed in accordance with temporal variations in the bandwidth (this is known as “transmission rate control”). In particular, data transmission using UDP (User Datagram Protocol) packets is different from TCP (Transmission Control Protocol) in that flow control is not performed in the transport layer, so that the transmission rate of the data must be controlled in the application layer. Additionally, the bandwidth must be ensured at intermediate nodes on the transmission path, such as routers, if the transmission quality is to be further improved.

The following is an assessment of conventional technologies pertaining to (1) bandwidth estimation, (2) transmission rate control, and (3) ensuring bandwidth.

(1) Conventional Technologies for Bandwidth Estimation

Conventional technologies for estimating the bandwidth can be broadly divided into the pathchar method and the Pair Packet method. The pathchar method and the Pair Packet method are described below.

(i) Pathchar method: Pathchar was offered as one method for estimating the bandwidth across a communications route. As with traceroute, packets with n in the TTL (Time To Live) field are sent to measure the RTT (Round Trip Time) between each of the routers by sending a TTL Expired message with ICMP (Internet Control Message Protocol) packets to the nth router on the route (A. B. Downey et al., “Using pathchar estimate Internet link characteristics”, ACM SIGCOMM '99).

With pathchar, the bandwidth is estimated by the statistical processing of a large amount of RTT data. By further application of statistical processing, pchar can increase accuracy while calculating the reliability of the estimated bandwidth.

(ii) Pair Packet Method: Bandwidth estimation via the Pair Packet method is performed as follows: A sending terminal sends bandwidth estimation packets consecutively to a receiving terminal. Differences in the packet processing speeds of the links cause intervals between the bandwidth estimation packets after they traverse a bottleneck. These intervals are measured to calculate the bandwidth of the bottleneck link using the size of the bandwidth estimation packets (R. L. Carter et al., “Measuring Bottleneck Link Speed in Packet-Switched Networks”, Technical Report BU-CS-96-006, Computer Science Department, Boston University, March 1996).

(2) Conventional Technologies for Transmission Rate Control

One example of conventional transmission rate control for UDP packets is the DAA (Direct Adjustment Algorithm) method (D. Sisalem et al., “The Direct Adjustment Algorithm: A TCP-Friendly Adaptation Scheme”, Technical Report GMD-FOKUS. August 1997. Available from http://www.fokus.gmd.dc/usr/sisalem). Another example is the LDA (Loss-Delay Based Adjustment Algorithm) method (D. Sisalem et al., “The Loss-Delay Based Adjustment Algorithm: A TCP-Friendly Adaptation Scheme”, in the proceedings of NOSSDAV'98, July, Cambridge, UK). With the DAA and LDA methods, the data loss rate is fed back to the sending terminal from the receiving terminal using RTCP (RTP Control Protocol), and the transmission rate of the data is changed based on the packet loss rate or the reception rate of the receiving terminal, for example.

There is also a method in which a single virtual buffer is assumed in the transmission path from the sending terminal to the receiving terminal, and the transmission rate is adjusted so that the amount of residual data in the virtual buffer becomes approximate to the target buffer amount (JP H11-308271A).

This method for adjusting the amount of sent data in accordance with the assessed transmission rate is different when sending real-time data and when sending accumulative data. For example, when delivering real-time data, such as when delivering video images directly from a surveillance camera, the encoding rate can be directly designated to the encoder. In the case of accumulative data, the encoding rate cannot be designated because the video has already been encoded. Consequently, for accumulative data, a method is adopted wherein identical data are encoded at different encoding rates and delivered at the transmission rate closest to the assessed transmission rate. This method is utilized by RealVideo, for example (http://service.jp.real.com/help/faq/surestream.html).

Other conceivable methods include matching the amount of sent data to the transmission rate by subjecting the encoded data to a culling process (for example, clipping the frames of video data) and then delivering, or restoring the video data and then again encoding at the designated encoding rate.

(3) Conventional Technologies for Ensuring Bandwidth

In FTTH (Fiber To The Home), a method is proposed for ensuring the minimum usable bandwidth and restricting the maximum usable bandwidth.

With the above conventional technologies alone, it is difficult to carry out data transmission with a stable transmission quality over a transmission path such as the Internet where there are various connection modes as well as variations in the transmission bandwidth. The following are examples of problems arising with these conventional technologies.

First Problem

In the pathchar method, 32 sets are sent out, wherein a single set includes packets of 46 sizes, ranging from 32 bytes to 1472 bytes at 32 byte intervals. Therefore, to measure the bandwidth of a single link, 1472 packets are sent and considerable time is needed to make the estimate.

Second Problem

When using the Pair Packet method to make an actual estimate of the bandwidth, packets for estimating the bandwidth are sent in addition to the data packets that are actually supposed to be sent, thus wasting transmission bandwidth. Furthermore, when making an actual estimate of the bandwidth, the sending and receiving terminals must be provided with a protocol for bandwidth estimation in addition to the protocol for the sending of data packets.

Third Problem

The DAA method and the LDA method use the packet loss rate to calculate the transmission rate. As with these methods, methods for controlling the transmission rate based on the loss rate are effective in Ethernets and in multicasts. However, when a narrowband transmission path is used in end-to-end communications over an IP network, a long period of time is required from the occurring of packet loss to the change in the transmission rate. This is because packet loss is created by buffer overflow of the bottleneck link, so information regarding the packet loss is not delivered to the receiving terminal until all of the data in the overflowed buffer has been transmitted.

On the other hand, methods in which RTT is used to calculate the amount of data buffering in the virtual buffer should permit the adjustment of the transmission rate before buffer overflow occurs. However, because a plurality of buffers on the transmission path resemble a single virtual buffer, the same operation is performed regardless whether the sent data are dispersed over a plurality of buffers or are concentrated in a single buffer. This operation becomes problematic when attempting to increase data throughput.

For example, when the sent data are buffered dispersed over a plurality of buffers, the amount of data residual in each of the buffers is small and the buffers have available space, so the throughput can be increased by setting a large target buffer amount. But when the buffering of the sent data concentrates on a single buffer, then that buffer does not have available space, so setting a large target buffer amount may cause buffer overflow and increased packet loss.

Therefore, the operation must be switched between buffering of data dispersed over a plurality of buffers and buffering of data concentrated in a single buffer. Such switching of the operation, however, is impossible when taking into account only a single virtual buffer.

Fourth Problem

When packet loss occurs, the transmission rate is changed in accordance with the packet loss, and when there is no packet loss, the method for controlling the rate can be switched, for example, to permit a prompt response to packet loss that may occur. However, currently there are no proposals for a specific method for achieving this.

As mentioned above in the third problem, in networks such as Ethernet and multicast networks, it is more effective to perform the transmission rate control based on the packet loss, whereas in end-to-end communication it is more effective to adopt the above method when using a transmission path with a large band gap.

Therefore, although the appropriate rate control method differs depending on the transmission path and the method of delivery, there have been no proposals for a method in which the transmission rate control is switched in accordance with the transmission path or the method of delivery.

Fifth Problem

When conducting transmission rate control, the initial value of the transmission rate is generally a problem. Making the initial value too large causes packet loss, whereas making the initial value too small, bandwidth cannot be effectively used in the initial stages.

Sixth Problem

In FTTH, for example, the encoding rate, the buffering time, and the transmission rate of the contents (such as video, audio, data) to be transmitted were not taken into consideration. For that reason, the transmission quality deteriorated considerably, depending on the transmitted contents.

Seventh Problem

One protocol for controlling the data transmission from the sending terminal with the receiving terminal is RTSP (H. Schulzrinne et al., “Real Time Streaming Protocol”, RFC 2326, Internet Engineering Taskforce, April 1998). With this protocol, the receiving terminal can request that the sending terminal start and stop sending data, for example, and in response to this request the sending terminal can start and stop sending the data. In conventional transmission paths, however, packets are typically input into a FIFO (First-In First-Out) queue, and when the packets cannot be input into this queue because it is full they are discarded. Thus, there was the problem that when the transmission path was congested, the request from the receiving terminal was delayed or lost due to this congestion, thereby causing delays in starting and stopping the sending of data. In particular, when switching to video of different transmission rates using RTSP to avoid congestion from the receiving terminal, it is necessary that the receiving terminal starts and stops the sending of data reliably and with low latency. Delays in stopping the sending of data further exacerbate the congestion, and delays in starting the sending of data result in choppiness in the video at the receiving terminal.

Also in the case of TCP, discarding packets without discriminating between control packets (such as SYN and FIN packets) and data packets causes delays in establishing and disconnecting sessions, and is problematic from the standpoint of transmission efficiency.

Eighth Problem

In networks in which wired networks and wireless networks are connected in alternation, transmitting AV data from an AV server on a wired network to a terminal on a wireless network, for example, requires transmission rate control to avoid congestion in the wired network. However, it is difficult for the receiving terminal to distinguish between packet loss caused by congestion in the wired network and packet loss caused by transmission error in the wireless network. Therefore, across such transmission paths, the application of a method for transmission rate control based on packet loss does not enable suitable transmission rate control. In the case of packet loss caused by congestion, the transmission rate must be lowered to avoid congestion, yet with packet loss caused by transmission errors, lowering the transmission rate does not change the packet loss rate, so it is not necessary for the transmission rate to be lowered.

Moreover, when applying a method for transmission rate control based on the RTT between the sending terminal and the receiving terminal, there is significant jitter in the RTT of the wireless network due to retransmission at the link layer level or processing such as handover and header compression, and thus an accurate transmission rate control was difficult (Nishida, “Thought of TCP enhancement in wireless networks”, Mobile Computing and Wireless Communication Research Group Proceedings 14-6, pp.39-45, Information Processing Society of Japan, September, 2000).

### DISCLOSURE OF THE INVENTION

In light of these conventional problems, it is an object of the present invention to achieve data transmission at a stable transmission quality over a transmission path such as the Internet in which there are various connection schemes and fluctuations in the transmission bandwidth (and in particular in connection schemes with mixed wired and wireless networks, in which it has conventionally been difficult to carry out data transmission at a stable transmission quality).

To achieve this object, in a first data sending/receiving method according to the present invention, a transmission rate from a sending terminal is determined in accordance with a state of receiving and/or sending data by all or a portion of intermediate nodes provided on a transmission path between the sending terminal and a receiving terminal.

A second data sending/receiving method according to the present invention includes a step in which an intermediate node adds congestion information indicating that congestion has occurred, if congestion occurs at the intermediate node, to data and sends the data to a receiving terminal; a step in which the receiving terminal determines a transmission rate in accordance with the congestion information and requests a sending terminal to change the transmission rate; and a step in which the sending terminal changes the data transmission rate in accordance with the request.

In a third data sending/receiving method according to the present invention, a plurality of bandwidth estimation packets are sent at a specific interval from a sending terminal over a transmission path between the sending terminal and a receiving terminal, and the arrival interval between the packets is measured at the receiving terminal to estimate the maximum usable bandwidth on the transmission path; wherein a portion of data packets sent from the sending terminal are used as the bandwidth estimation packets; information expressing which data packets of the sent data packets were sent for bandwidth estimation is marked in the sent data packets or sent independently to the receiving terminal; and the results of the measurement at the receiving terminal are sent to the sending terminal.

In a fourth data sending/receiving method according to the present invention, packets having information regarding control for sending/receiving data are given priority transmission over data packets during congestion.

### BRIEF DESCRIPTION OF THE DRAWINGS

FIG. 1 is a schematic drawing illustrating the overall configuration of the first embodiment of the present invention.

FIG. 2 is a flowchart illustrating the operation of the sending terminal according to the first embodiment of the present invention.

FIG. 3 is a flowchart of the transmission rate control according to the first embodiment of the present invention.

FIG. 4 is a diagram representing a connection scheme in which there is a mixture of wired and wireless networks according to the second embodiment of the present invention.

FIG. 5 is a diagram representing a separate connection scheme in which there is a mixture of wired and wireless networks according to the second embodiment of the present invention.

FIG. 6 is a schematic drawing illustrating the overall configuration of the second embodiment of the present invention.

FIG. 7 is a sequence diagram between the sending terminal and the receiving terminal according to a second embodiment of the present invention.

FIG. 8 is a diagram illustrating the description of information related to the transmission rate according to the second embodiment of the present invention.

FIG. 9 is a flowchart of the transmission rate control according to the second embodiment of the present invention.

FIG. 10 is a diagram representing the connection mode in multicasts according to the third embodiment of the present invention.

FIG. 11 is a diagram representing another connection mode in multicasts according to the third embodiment of the present invention.

FIG. 12 is a schematic drawing illustrating the overall configuration of the third embodiment of the present invention.

FIG. 13 is a sequence diagram between the sending terminal and a plurality of receiving terminals according to a third embodiment of the present invention.

FIG. 14 is a flowchart for the division of a plurality of receiving terminals into groups according to the third embodiment of the present invention.

FIG. 15 is a schematic drawing illustrating the overall configuration of the fourth embodiment of the present invention.

FIG. 16 is a flowchart expressing the operation of the sending terminal according to the fourth embodiment of the present invention.

FIG. 17 is a flowchart of the transmission rate control according to the fourth embodiment of the present invention.

FIG. 18 is a flowchart of the transmission rate control according to the fifth embodiment of the present invention.

FIG. 19 is a schematic drawing illustrating the overall configuration of the sixth embodiment of the present invention.

FIG. 20 is a sequence diagram between the sending terminal and the receiving terminal according to a sixth embodiment of the present invention.

FIG. 21 is a schematic drawing illustrating the overall configuration of the seventh embodiment of the present invention.

FIG. 22 is a sequence diagram between the sending terminal and the receiving terminal according to a seventh embodiment of the present invention.

FIG. 23 is a schematic drawing illustrating the overall configuration according to the eighth embodiment of the present invention.

FIG. 24 is a flowchart expressing the operation of the sending terminal according to the eighth embodiment of the present invention.

FIG. 25 is a schematic drawing illustrating the overall configuration according to the ninth embodiment of the present invention.

FIG. 26 is a sequence diagram between the sending terminal and the receiving terminal according to a ninth embodiment of the present invention.

FIG. 27 is a schematic drawing illustrating the overall configuration according to the tenth embodiment of the present invention.

### BEST MODE FOR CARRYING OUT THE INVENTION

The following is a description of embodiments of the present invention, with reference to the drawings.

First Embodiment

The present embodiment relates to a transmission rate control method for determining the transmission rate based on the state of sending or receiving at the intermediate nodes, and is primarily for solving the above-described third and fifth problems.

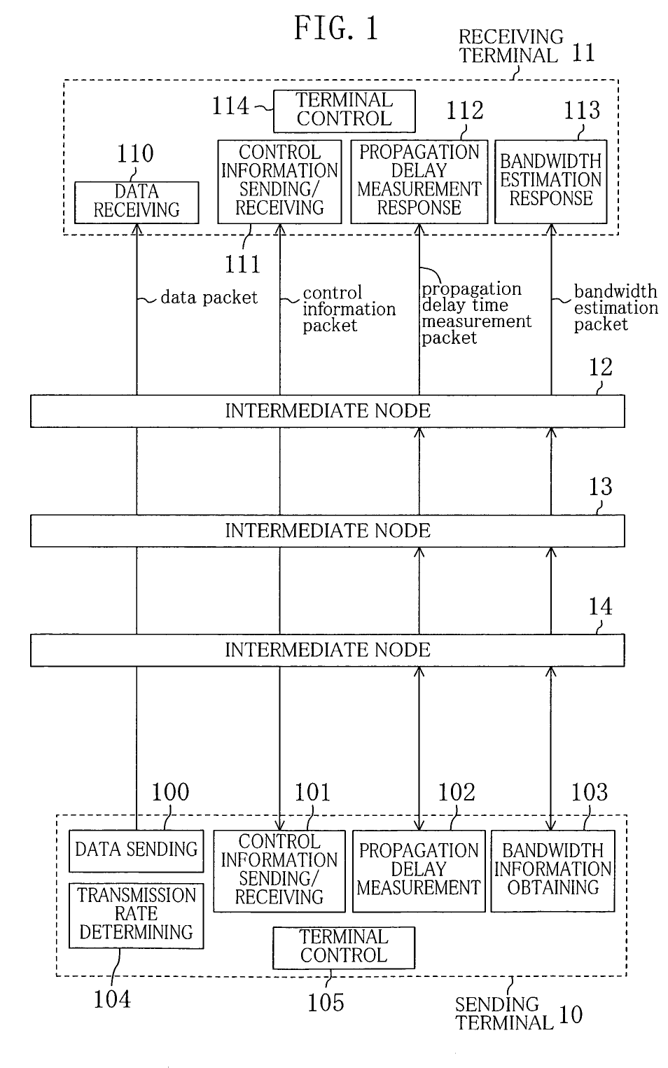

FIG. 1 is a diagram illustrating the overall configuration of the present embodiment. In a sending terminal 10, a data sending portion 100 is a means for taking data from an input such as a capture, a microphone, or a file, encoding the data if necessary, packetizing the data if necessary, and sending data packets to a receiving terminal 11. It is also a means for measuring the data amount of the sent data packets. Furthermore, it is also a means for adjusting the transmission rate of the data packets in accordance with the transmission rate determined by a transmission rate determining portion 104. A data sending protocol such as RTP (Real Time Transport Protocol) is presumed as the protocol for sending the data packets.

A control information sending/receiving portion 101 is a means for sending/receiving control information pertaining to data packets to and from the receiving terminal 11. Control information is assumed to be information such as the packet loss rate, the RTT, and the maximum sequence number of the data packets received by the receiving terminal 11. The protocol for sending/receiving control information is presumed to be a data transmission control protocol such as RTCP (RTP Control Protocol).

A propagation delay measurement portion 102 is a means for sending packets capable of measuring the RTT (RTT measurement packets), for example PING (Packet Internet Groper) packets, to intermediate nodes 12, 13 and 14, or the receiving terminal 11, and thus measuring the RTT. The RTT measurement packets can be sent to all of the intermediate nodes 12 to 14 and the receiving terminal 11, or can be sent only to intermediate nodes with a high possibility of residual data packets based on the results of past measurements. It is also possible to send the RTT measurement packets to intermediate nodes with a link bandwidth that is narrower than a designated threshold value. Furthermore, it is also possible to let the propagation delay measurement portion 102 measure fluctuations in the RTT instead of the RTT itself.

A bandwidth information obtaining portion 103 is a means for obtaining the bandwidth of the links on the transmission path between the sending terminal and an intermediate node, between intermediate nodes, and between the receiving terminal and an intermediate node (referred to as “bandwidth information”). As a method for obtaining bandwidth information, it is possible to obtain bandwidth information of the links from the intermediate nodes using a device management protocol such as SNMP (Simple Network Management Protocol), or to use a bandwidth estimating method such as pchar, pathchar, or the method described later in the eighth embodiment. It should be noted that because the bandwidth information obtaining portion 103 is a means for detecting links which become bottlenecks, it may also not be provided if the configuration of the network is evident, the bottleneck link is known, and the bandwidth of the bottleneck link is known or it is not necessary to know the bandwidth of the bottleneck link.

The transmission rate determining portion 104 is a means for determining the transmission rate of the data packets based on the RTT to and from the receiving terminal 11 and to and from intermediate nodes 12 to 14, the bandwidth information, the data amount of the sent data packets, and the amount of sent data that is residual in the intermediate nodes, for example, obtained from the data sending portion 100, the control information sending/receiving portion 101, the propagation delay measurement portion 102, and the bandwidth information obtaining portion 103.

A terminal control portion 105 is a means for controlling these portions.

In the receiving terminal 11, a data receiving portion 110 is a means for receiving data packets from the sending terminal 10, unpacking the packets if necessary, decoding if necessary, and delivering the data to an output such as a monitor, a speaker, or a file.

A control information sending/receiving portion 111 is a means for sending/receiving control information pertaining to the data packets to and from the sending terminal 10.

A propagation delay measurement response portion 112 is a means for sending response packets in response to the RTT measurement packets, such as PING packets, that are sent from the propagation delay measurement portion 102. The propagation delay measurement response portion 112 does not have to be provided if the RTT can be measured by the control information sending/receiving portion 111 (for example, when RTCP is used for the control information transmission protocol).

A bandwidth estimation response portion 113 is a means for responding to the bandwidth estimation packets from the sending terminal 10. The bandwidth estimation response portion 113 does not have to be provided if the bandwidth information obtaining portion 103 obtains the bandwidth information of the links from the intermediate nodes 12 to 14 using a device management protocol such as SNMP. Also, the bandwidth estimation response portion 113 does not have to be provided if the sending terminal 10 is not provided with the bandwidth information obtaining portion 103.

A terminal control portion 114 is a means for controlling the various portions of the receiving terminal 11.

The intermediate node 12 is a node that forwards received data packets to a destination, like an IP router. Furthermore, it is also presumed to (1) buffer the data packets when the arrival rate is higher than the bandwidth of the link to the destination of the transmission, (2) be provided with a device management protocol for bandwidth information notification, or to respond to bandwidth estimation packets (not necessary if the sending terminal 10 is not provided with the bandwidth information obtaining portion 103), and (3) respond to RTT measurement packets from an authorized sending terminal 10, that is, a terminal 10 for which connection has been allowed.

With respect to (3), the method for authorizing the sending terminal can be a method in which the IP address of the sending terminal to respond to is registered in the RTT measurement packets, and when the RTT measurement packets are received, the IP address is verified and responses are made only to registered sending terminals.

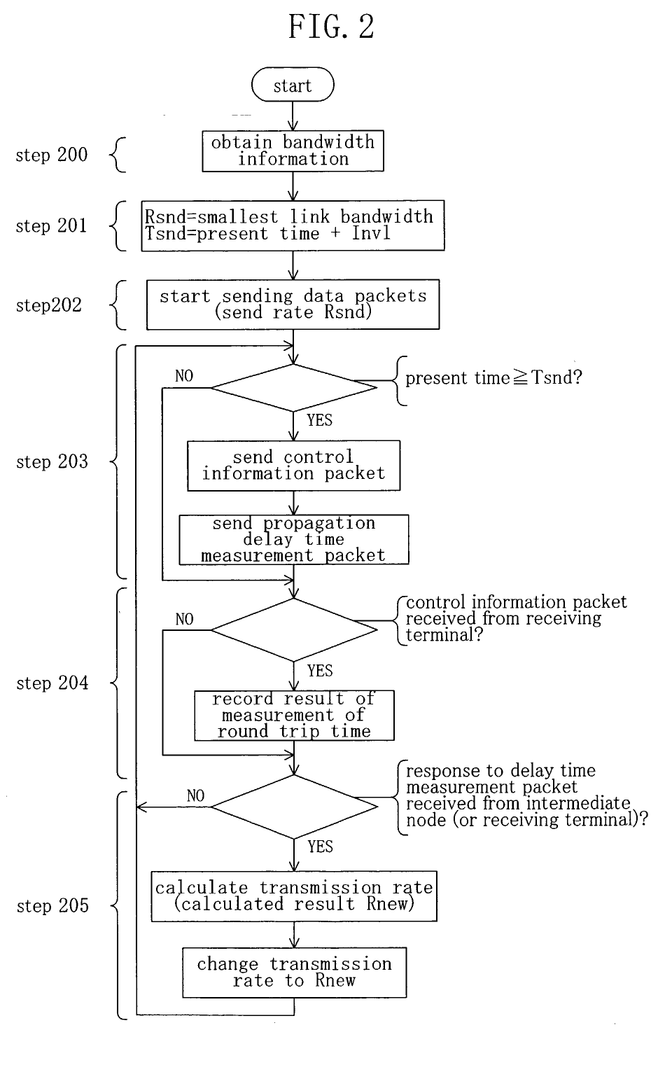

FIG. 2 is a flowchart illustrating how the sending terminal 10 operates according to the present embodiment. The sending terminal 10 obtains bandwidth information before sending data (step 200). This step is performed by the bandwidth information obtaining portion 103. This step is unnecessary when intermediate nodes that become bottlenecks are known in advance and the bandwidth of the bottleneck link is known or the information of the bandwidth of the bottleneck link is not necessary when determining the transmission rate.

Next, the initial value of the transmission rate R_{snd} of the data packets is determined in accordance with the obtained bandwidth information, and the time T_{snd} at which the control information packets are sent is determined based on the present time and the send interval Invl of the control information packets (step 201). The initial value of the transmission rate is taken as the value of the bandwidth of the narrowest link using the bandwidth information obtained in step 200. Thus, the fifth problem is solved. When the bandwidth of the bottleneck link is not known because step 200 has been omitted, sending is started at a minimum transmission rate, for example. The initial value of the transmission rate is determined by the transmission rate determining portion 104, and the send time of the control information packets is determined by the control information sending/receiving portion 101.

Next, sending of the data packets is started (step 202). This step is performed by the data sending portion 100. At the send time of the control information packets, RTT measurement packets and control information packets are sent (step 203). The RTT measurement packets are sent by the propagation delay measurement portion 102, and the control information packets are sent by the control information sending/receiving portion 101. Furthermore, when a response to the RTT measurement packets is received, the results of the measurement are recorded (step 204). This step is performed by the propagation delay measurement portion 102. When control information packets are received from the receiving terminal 11, the next transmission rate R_{new} is determined in accordance with the data amount, the bandwidth information, and the measured RTT of the sent data packets (step 205). The operation of this step is performed by the transmission rate determining portion 104. Repeating steps 203 to 205, the sending terminal 10 continually updates the transmission rate.

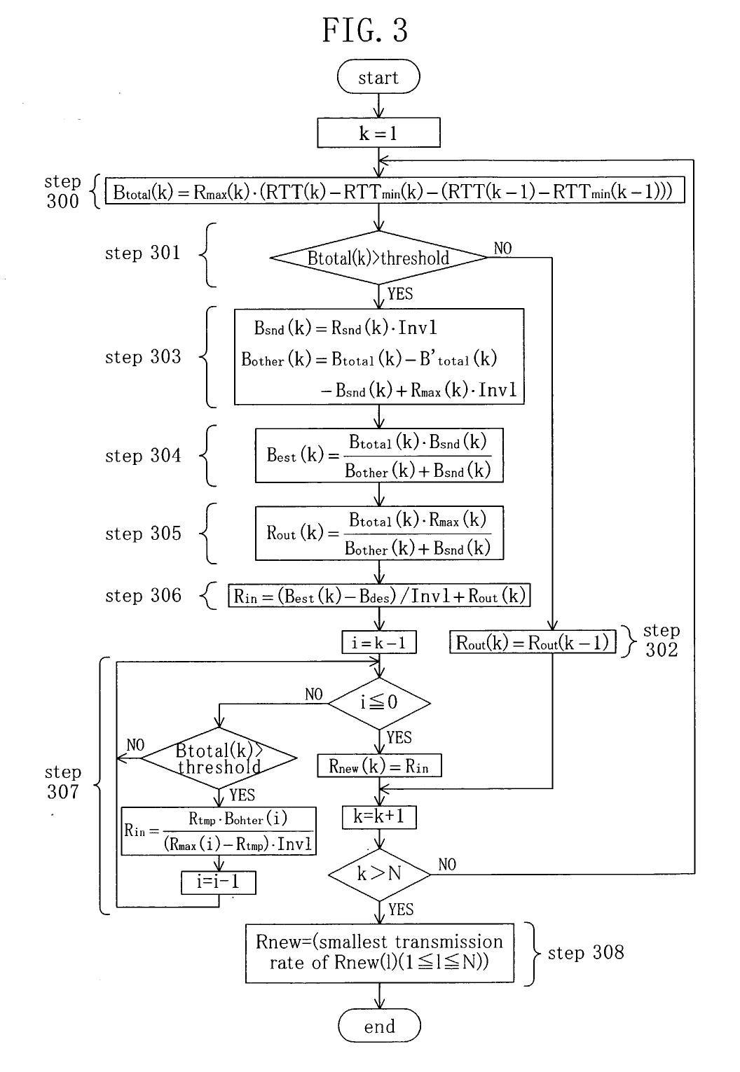

FIG. 3 is a flowchart illustrating the operation of the sending terminal 10 in the step for determining the transmission rate (step 205) in FIG. 2. This operation is performed by the transmission rate determining portion. 104.

Let us assume that N intermediate nodes exist between the sending terminal 10 and the receiving terminal 11, and the k-th intermediate node from the sending terminal 10 is the Node(k). The total data amount Bₜₒₜₐₗ(k) including other flows remaining in the Node(k) is estimated from the round trip times RTT(k) and RTT(k−1) between the sending terminal 10 and Node(k) and Node(k−1), and the link bandwidth Rₘₐₓ(k) of the Node(k) (step 300). Here, RTTₘᵢₙ(k) is the minimum value of the RTT values heretofore measured between the sending terminal 10 and the Node(k). When the data amount Bₜₒₜₐₗ(k) is larger than a threshold value, then it is determined that there are residual data packets in the buffer, and when it is smaller than the threshold value, then it is determined that there are no data packets in the Node(k) (step 301).

When it is determined that there are no residual data packets, the output rate from Node(k) is taken as equivalent to the output rate of Node(k−1), the output rate Rₒᵤₜ(k) of the data packets sent from the intermediate node is calculated, and the procedure moves on to process the Node(k+1) (step 302).

When it is determined that there are residual data packets, the processes of steps 303 to step 307 are performed.

First, the data amount B_{snd}(k) sent from the sending terminal 10 that flowed into the Node(k) during Invl and the data amount Bₒₜₕₑᵣ(k) of other flows to the Node(k) during Invl are calculated (step 303). Here, Invl is the send time interval between control information packets sent from the receiving terminal 11. R_{snd}(k) is the input rate of the flow of data packets from the sending terminal 10 into the Node(k), and the value thereof is equal to the output rate Rₒᵤₜ(k−1) of the Node(k−1). Also, B′ₜₒₜₐₗ(k) is the total amount of data, including other flows, residual in the Node(k) obtained by the previous measurement.

Next, the residual amount of the sent data packets Bₑₛₜ(k) is calculated as the value for which the ratio of B_{snd}(k) to Bₒₜₕₑᵣ(k) is equal to the ratio of the amount of data sent by the sending terminal 10 that is residual in the Node(k) to the data amount of other flows, that is, the value for which

Bₒₜₕₑᵣ(k):B_{snd}(k)=Bₜₒₜₐₗ(k)−Bₑₛₜ(k):Bₑₛₜ(k) (step 304).

Also, the output rate Rₒᵤₜ(k) of the sent data packets from the Node(k) is calculated as the value for which the ratio of B_{snd}(k) to Bₒₜₕₑᵣ(k) is equal to the ratio of the sent data amount flowing from the Node(k) during Invl to the data amount of other flows, that is, the value for which

Bₒₜₕₑᵣ(k):B_{snd}(k)=(Rₘₐₓ(k)−Rₒᵤₜ(k))×Invl:Rₒᵤₜ(k)×Invl (step 305).

Next, the input rate Rᵢₙ is set such that the sent data amount residual in the Node(k) reaches a target data amount B_{des} after Invl (step 306).

Lastly, R_{new}(k) is found such that the input rate to the Node(k) becomes Rᵢₙ (step 307).

The above calculations are performed for all intermediate nodes, and the smallest value for R_{new}(k) is taken as the next transmission rate R_{new} (step 308).

It should be noted that instead of the above-described method for determining the transmission rate, it is also conceivable to use an algorithm in which the RTT or the RTT jitter between the intermediate nodes and the sending terminal is used to determine the transmission rate, or an algorithm in which information on packet loss at the intermediate nodes is used.

For example, the following is an example of an algorithm using the RTT. First, the RTT(k), the RTT(k−1), the RTTₘᵢₙ(k), and the RTTₘᵢₙ(k−1) are used to calculate the time T(k) that observed packets are residual in the Node(k):

T(k)=RTT(^{k})−RTTₘᵢₙ(k)−(RTT(k−1)−RTTₘᵢₙ (k−1)).

Then, R_{snd}(k) is calculated such that T(k) becomes close to a threshold value Tₜₕ (target value of the time that data reside in intermediate nodes, fixed value set by user):

R_{snd}(k)=(1−T(k)/Tₜₕ)×Rₘₐₓ(k)/n+Rᵣₑᵥ.

Here, Rₘₐₓ(k) is the maximum transmission bandwidth of the link which has been measured during the bandwidth estimation. The parameter n is for determining the ratio at which the transmission rate increases or decreases. When this value is set to n=N, then, if T(k) is constantly 0 (that is, when congestion never occurs), N steps are required from the state of Rᵣₑᵥ=0 until the maximum transmission rate is achieved. It is also possible not to perform bandwidth estimation and to have the user suitably determine the value of Rₘₐₓ(k). In this case, the bandwidth information obtaining portion 103 becomes unnecessary, so there is the advantage that installation can be simplified and the time for conducting bandwidth estimation can be omitted. R_{rcv} is the reception rate calculated from feedback information from the receiving terminal 11, and for example when receiving feedback information using RTCP, can be calculated as

R_{rcv}=P×(Seqₘₐₓ(j)−Seqₘₐₓ(j−1))/I×(1−Loss).

Here, P is the average sent packet size, I is the reception interval of the RTCP receiver report, Seqₘₐₓ(j) is the maximum sequence number of the j-th RTCP receiver report, and “Loss” is the packet loss rate.

The above calculations are performed for all of the intermediate nodes, and the smallest R_{snd}(k) is taken as the transmission rate R_{new} of the data.

The following algorithm is an example of an algorithm in which RTT jitter is used. First, the average value ST(k) of the past m times of T(k) indicated above and the standard variation J(k) of T(k) are used to calculate

Tₜₕ(k)=ST(k)+k×J(k).

Here m and k are constants. Tₜₕ(k) and T(k) are compared, and when Tₜₕ(k) is larger than T(k), the transmission rate R_{snd}(k) to the Node(k) is given as R_{snd}(k)=R_{rcv}+B, and when Tₜₕ(k) is smaller than T(k), then R_{snd}(k)=R_{rcv}−B. Here, B is the value determining the size of the variations of increases and decreases in the transmission rate. The above calculations are performed for all the intermediate nodes, and the smallest value is taken as the transmission rate R_{new}.

Furthermore, the following algorithm can be applied when the information on packet loss is used. First, an arrangement is assumed in which the packet loss rate is notified from the intermediate nodes, and the transmission rate R_{new} is calculated as

R_{new}=(present transmission rate)×(1−Loss).

Alternatively, an arrangement is assumed in which packet loss due to buffer overflow is notified from the intermediate nodes, and when a notification of packet loss is received, the transmission rate is exponentially or linearly reduced, for example, by R_{new}=(present transmission rate)×α or R_{new}=(present transmission rate)−α′ (where α and α′ are constants).

It should be noted that in the above example, the calculations for R_{snd}(k) were performed for all intermediate nodes, however, it is also possible to perform the above calculations by selecting a bottleneck link on the transmission path and sending RTT measurement packets only to the intermediate nodes connected to that link. A conceivable method for selecting the bottleneck link, for example, is to regard a link fulfilling the condition

Rₘₐₓ(j)<α×min(Rₘₐₓ(i))

as a bottleneck link. Here, min(X(i)) represents the smallest value of the elements of X(i). Also, a is a value representing the detection sensitivity of bottleneck links, and the larger this value, the more links are determined to be bottleneck links.

Second Embodiment

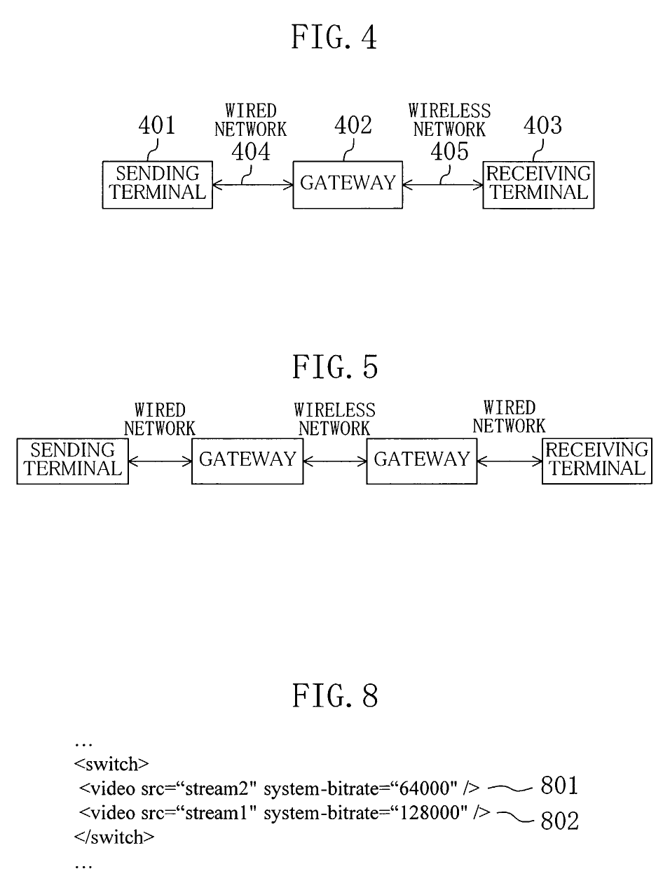

The following explains a solution of the eighth problem. If the transmission rate control method of the present invention, in which the congestion state of the intermediate nodes is utilized, is used when transmitting data over a network such as that shown in FIG. 4, in which a wired network 404 and a wireless network 405 are alternately connected, from a sending terminal 401 on the wired network 404 to a receiving terminal 403 on the wireless network 405, for example, then transmission rate control can be performed without being affected by the jitter of propagation delay in the wireless network 405. A case in which a mobile terminal such as a portable telephone is the receiving terminal 403 and is connected to a server (sending terminal) 401 is conceivable as such a connection mode. This means, the server 401 and a gateway 402 are connected by a wired network 404 such as an Ethernet or by ATM (Asynchronous Transmission Mode), and the gateway 402 and the receiving terminal 403 are connected by a wireless network 405 such as a wireless LAN (Local Area Network) or by W-CDMA (Wideband Code Division Multiple Access). Another similar connection mode is a case in which a home network is configured by wireless LAN or BlueTooth and is connected to the Internet through a telephone line, for example, from a home gateway 402, for example, connecting the home network to an outside network. Conceivable applications include video delivery such as Video on Demand or two-way communication such as TV telephone.

To offer a more specific explanation, congestion ordinarily occurs in the gateway (or router) 402 for connecting the wired network 404 to the wireless network 405, so the state of congestion between the sending terminal 401 and the gateway 402 can be measured, for example, using RTT (other intermediate nodes may also be included) to control the transmission amount from the sending terminal 401. That is, the gateway 402 may be regarded as one of the intermediate nodes 12 to 14 of the first embodiment, and transmission rate control is performed according to the state of that intermediate node.

When measuring the RTT or jitter in the RTT to detect the state of congestion between the sending terminal 401 and the receiving terminal 403, it is often that case that there is large jitter in the wireless network 405 and the state of congestion cannot be accurately detected. However, if the present invention is adopted, the RTT or RTT jitter of only the wired network 404 between the sending terminal 401 and the gateway 402 is measured, thus permitting accurate detection of congestion. Furthermore, the cause of packet loss is congestion in the wired network 404 and transmission error in the wireless network 405, so when packet loss is observed between the sending terminal 401 and the receiving terminal 403, it is not possible to conduct appropriate transmission rate control, as was mentioned in the eighth problem. However, if the present invention is applied, only the packet loss on the wired network 404 between the sending terminal 401 and the gateway 402 is measured, and therefore it is possible to measure only the packet loss caused by congestion and to execute appropriate transmission rate control.

It should be noted that aside from the arrangement of FIG. 4, a connection mode such as that shown in FIG. 5, or connection modes in which a plurality of wired and wireless networks are traversed are also conceivable, and the present invention can be applied in such connection modes as well if there is a bottleneck link in the wired network between the sending terminal and the first gateway from the sending terminal and there are no other bottleneck links from the second wired network onward. A conceivable connection mode for that shown in FIG. 5 is a home network that is constructed as wired and is connected to an outside network by FWA (Fixed Wireless Access), for example. A similar connection mode would be a case in which a network inside an automobile is constructed as wired and connected to an outside network by DSRC (Dedicated Short Range Communication), for example. Conceivable applications include video delivery such as Video on Demand and two-way communications such as TV telephone.

The following two examples are methods conceivable in addition to the method mentioned above to control, in response to congestion occurring in the wired network, the data transmission amount over a network such as shown in FIG. 4 and FIG. 5, in which wireless and wired networks are connected in alternation.

In the first method, at least one of the RTT, the packet loss, and the jitter, for example, between the sending terminal and the receiving terminal is measured to calculate the variation width or period of change thereof, and it is determined whether the network is in a state in which congestion is occurring or in a state in which handover or transmission errors are occurring. Then, if the state is determined to be the former, the sending terminal controls the amount of sent data in accordance with the state of the congestion.

In the second method, when congestion occurs in a router such as a gateway, the ECN (Explicit Congestion Notification) flag of IP packets for indicating that congestion has occurred is used, and the router notifies the receiving terminal of the congestion (referred to as “ECN method”).

First, the sending terminal encodes identical contents with several different encoding rates. When sending in real time, such encoding can be performed by a plurality of encoders, and when sending stored contents, the encoding can be performed in advance with a plurality of encoding rates. The sending terminal uses SMIL (Synchronized Multimedia Integration Language), for example, to indicate to the receiving terminal the plurality of encoding rates that are sent and the receiving terminal selectively receives one of these using RTSP, for example. If congestion occurs during sending, the above-mentioned ECN flag is set by the router, and thus the receiving terminal is able to detect the occurrence of congestion by monitoring the ECN flag. Then, when congestion is detected, the receiving terminal uses RTSP, for example, to perform reception (and reproduction) by switching the selection to a lower encoding rate in order to alleviate the state of congestion. It should be noted that to which encoding rate the selection is switched can be determined, for example, by comparing the number of IP packets with set ECN flag that have been received during a predetermined time period to a predetermined threshold value. Of course, (1) if no IP packets with set ECN flag are received during the predetermined period, or (2) if the number of IP packets with set ECN flag received during the predetermined period is less than the predetermined threshold value, then, by switching the selection to a higher encoding rate using RTSP, for example, it is possible to increase the transmission rate while avoiding congestion, and it is possible to achieve a content transmission of high quality. As in the above case, which encoding rate to switch the selection to can be determined by comparing the number of IP packets with set ECN flag to a predetermined threshold value.

With the ECN method, congestion is indicated explicitly to the receiving terminal by using an ECN flag. Thus, the receiving terminal can accurately detect congestion even across a transmission path in which wired and wireless networks are connected in alternation, and appropriate transmission rate control can be performed. Furthermore, because in the ECN method the transmission rate is switched from the receiving terminal, it has the effect that user requests can be easily reflected. This means that the range of variation in the transmission rate only has to be registered in the receiving terminal. In the case of a transmission rate control scheme controlled from the sending terminal, the range of variation in the transmission rate must be registered in the sending terminal, so a protocol for registration, for example, is required. Additionally, the ECN method permits congestion detection with the receiving terminal and the execution of appropriate transmission rate control, even for a connection mode in which a plurality of wired networks and wireless networks are connected to one another.

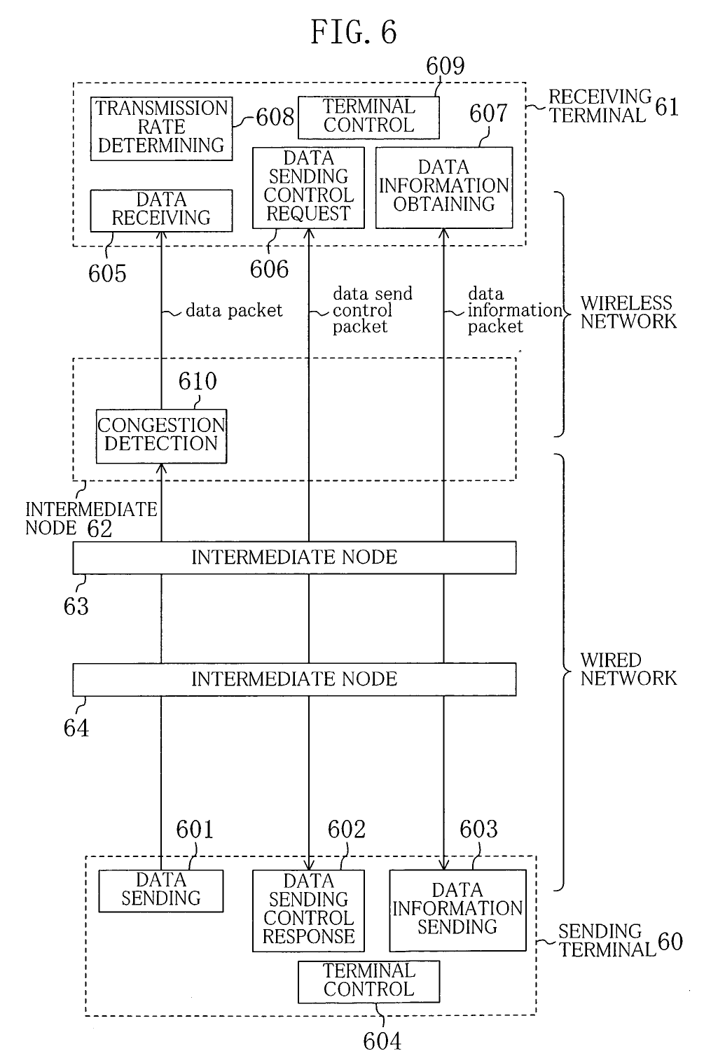

FIG. 6 is a schematic drawing representing an overall view of the ECN method according to the present embodiment. A data sending portion 601 and a terminal control portion 604 in a sending terminal 60 and a terminal control portion 609 in a receiving terminal 61 are equivalent to those of FIG. 1.

A data information sending portion 603 is a means for reporting the data transmission rate that can be sent by the sending terminal 60. SMIL, for example, can be adopted as the descriptive language for describing the data transmission rate that can be sent by the sending terminal 60.

A data transmission control response portion 602 is a means for receiving a request such as data send/stop from the receiving terminal 61, orders the data sending portion 601 to start or stop the sending of data based on this request, and responds to the receiving terminal 61 with the result of whether that request has been accepted. RTSP, for example, can be adopted as the sending/receiving protocol for request/response between the sending terminal 60 and the receiving terminal 61.

A congestion detection portion 610 provided in an intermediate node 62, for example, is a means for monitoring the state of data sending and receiving in that intermediate node 62, and when congestion occurs, it adds congestion information (such as flags) indicating that congestion has occurred to the data packets, and sends those data packets to the receiving terminal 61. The congestion information can be indicated using the ECN flag in IP packets, for example. The congestion detection portion 610 can be installed in all intermediate nodes 62, 63, and 64, or only in intermediate nodes in which congestion tends to occur.

In the receiving terminal 61, a data receiving portion 605 corresponds to the data receiving portion 110 of FIG. 1 to which the function of notifying a transmission rate determining portion 608 of the congestion information added by the intermediate node 62 has been added.

A data information obtaining portion 607 is a means for obtaining the data transmission rates that can be sent by the sending terminal 60 and notifying them to a transmission rate determining portion 608.

The transmission rate determining portion 608 is a means for determining the transmission rate in accordance with the notified congestion information and the transmission rates that can be sent by the sending terminal 60, and notifying a data sending control request portion 606 of the determined transmission rate.

The data sending control request portion 606 is a means for sending a request such as data send/stop based on the transmission rate determined by the transmission rate determining portion 608.

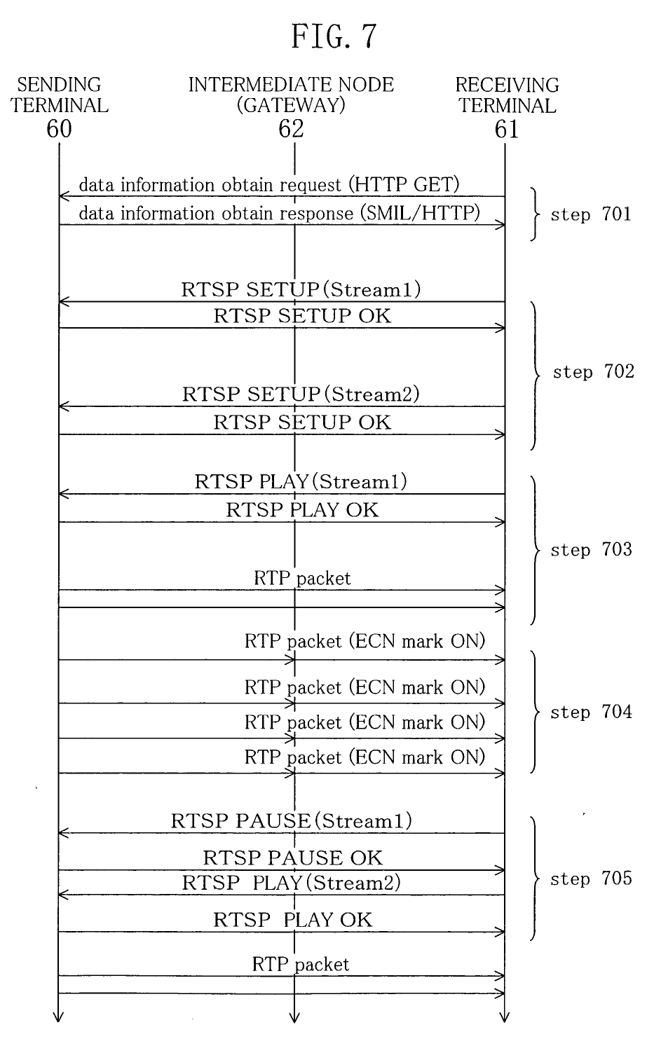

FIG. 7 is a sequence example representing the flow of the operation of the present ECN scheme. First, using SMIL the receiving terminal 61 obtains the transmission rates that can be sent by the sending terminal 60 (step 701). FIG. 8 shows the portion of the SMIL description used in this example that pertains to the transmission rate. Looking at FIG. 8, it can be understood that in this example data can be sent at two different transmission rates, namely 64 Kbps (801) if Stream 2 is selected, and 128 Kbps (802) if Stream 1 is selected.

In accordance with the received SMIL description, the receiving terminal 61 uses the SETUP method of RTSP to prepare data of all transmission rates such that they are in a state in which they can be sent (Ready state) (step 702). Of course, it is not absolutely necessary that data of all transmission rates are put into the Ready state before the sending of data begins, and it is also possible to put only data of a portion of the transmission rates into the Ready state before the sending of data begins, and to put the data of other transmission rates into the Ready state as necessary during the sending of data.

Next, the receiving terminal 61 selects one of the transmission rates that can be sent by the sending terminal 60 and requests that the sending terminal 60 starts sending data. The sending terminal 60 then starts sending data in response to that request (step 703). In FIG. 7, RTP is adopted as the protocol for sending data, and the sending of data is started at 128 Kbps (Stream 1). Thereafter, if congestion occurs in the intermediate node 62 during the sending of data, the ECN flag is used to notify the receiving terminal 61 that congestion has occurred (step 704). The receiving terminal 61 determines the transmission rate based on the ECN flag set by the intermediate node 62, and to change the transmission rate uses the PAUSE method of RTSP to temporarily stop the sending of data that are currently being received and uses the PLAY method of RTSP to notify the sending terminal 60 to send the data at another transmission rate from where the data that were currently received left off. The PLAY method of RTSP has a header (Range header) for indicating the reproduction range, so this can be used to start sending from midway in the data. In accordance with the pause/play request, the sending terminal 60 pauses the sending of data at the transmission rate currently being sent, and starts the sending of data at another transmission rate (step 705). In FIG. 7 the sending of data at 128 Kbps (Stream 1) is paused, and sending of data at 64 Kbps (Stream 2) is started.

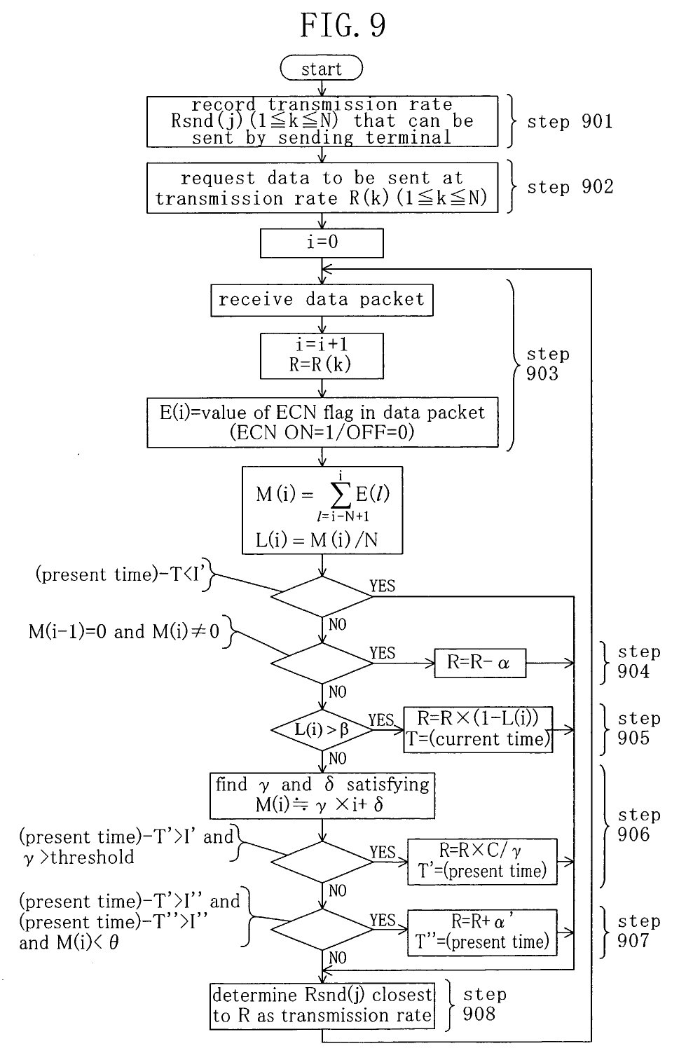

FIG. 9 is a flowchart illustrating an algorithm for determining the transmission rate with the transmission rate determining portion 608. First, the transmission rates R_{snd}(j)(1≦j≦N) that can be sent by the sending terminal 60 are obtained and recorded (step 901). In this example, it is presumed that N discrete transmission rates can be sent by the sending terminal 60.

Next, one of the transmission rates that can be sent by the sending terminal 60 is determined as the initial transmission rate, and is notified to the data sending control request portion 606 (step 902). Then, each time a data packet is received, the number of packets among the past N number of received packets where the ECN flag was set is taken as M, and the ratio L=M/N is calculated (step 903). Here, the M and L that are calculated when the i-th data packet is received are denoted as M(i) and L(i), respectively, and the transmission rate is determined according to the following rules.

(1) If M(i−1)=0 and M(i)≠0, then the transmission rate is decreased by α from the transmission rate R that is currently being received (step 904). Here, α is a fixed value.

(2) If L(i)>β (β is a constant where 0<β<1), then the transmission rate is decreased to (current transmission rate)×(1−L(i)). After this step has been carried out, the transmission rate is not changed for 1 seconds (step 905).

(3) A first approximation line M(i). γ×i+δ is determined from M(1)(i−K≦1≦i, where K is a constant) by the method of least squares, for example, and if γ is larger than a certain threshold value, then the transmission rate is decreased to (current transmission rate)×C/γ (where C is a constant). After this step has been performed, the step is not performed for I′ seconds (step 906). This step serves the role of lowering the transmission rate when M(i) tends to increase.

(4) If the transmission rate has been changed and I″ seconds have passed, and M(i)<θ (where θ is a constant), then the transmission rate is increased to (current transmission rate)+α′ (where α′ is a constant). After this step has been performed, the step is not performed for I″ seconds (step 907).

(5) When none of (1) to (4) are applicable, the transmission rate is not changed.

The value of the transmission rate determined by the above steps is compared to the transmission rates that can be sent by the sending terminal 60, and the closest value thereto is chosen as the transmission rate. When this transmission rate is different from the transmission rate at which reception is currently being performed, the new transmission rate is notified to the data sending control request portion 606 (step 908).

The present embodiment describes a method for determining the transmission rate. With respect to a method for adjusting the amount of sent data in accordance with the determined transmission rate, a method mentioned earlier in the conventional examples can be used. That is, for real time data, adjustment is possible by indicating the encoding rate directly to the encoder. For accumulative data, adjustment is possible by encoding the data at a plurality of encoding rates and sending the data of the encoding rate closest to the determined transmission rate, for example.

Third Embodiment

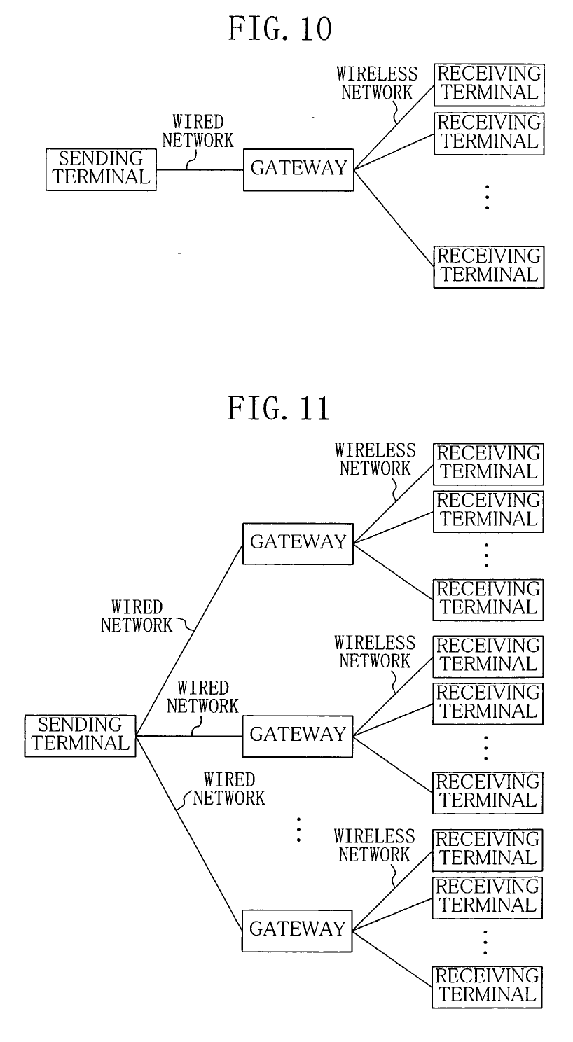

The present invention is not limited to one-to-one data sending/receiving, and can also be used for one-to-many data sending/receiving such as multicasts. As shown in FIG. 10, in the case of multicasts over a connection scheme in which a sending terminal and a plurality of receiving terminals are connected via a single gateway, the amount of data sent from the sending terminal can be controlled by measuring at least one of for example the RTT, packet loss, and jitter between the sending terminal and the gateway, in the same way as in the above. This means that the control is carried out by measuring the state of congestion in the wired network.

As shown in FIG. 11, however, if determining the transmission rate in a connection scheme in which a sending terminal is connected to a plurality of receiving terminals via a plurality of gateways, transmission rate control optimal for all receiving terminals cannot be performed with only the transmission rate control method explained above, because there is more than one wired network transmission path.

The present embodiment provides a method for transmission rate control in a connection scheme in which the sending terminal is connected to a plurality of gateways.

When a sending terminal is connected to a plurality of receiving terminals via a plurality of gateways, gateways in which congestion is occurring are separated into groups in accordance with the state of congestion at the plurality of gateways obtained by measurement, and the amount of sent data is adjusted for each group. With IPv4 (Internet Protocol Version 4), the value of the TTL can be used to limit the scope of these groups. For example, the amount of sent data is reduced for groups to which receiving terminals experiencing congestion belong, and the amount of sent data is increased for groups not experiencing congestion. By such grouping, fine control of the amount of sent data can be performed in response to the state of congestion across the network.

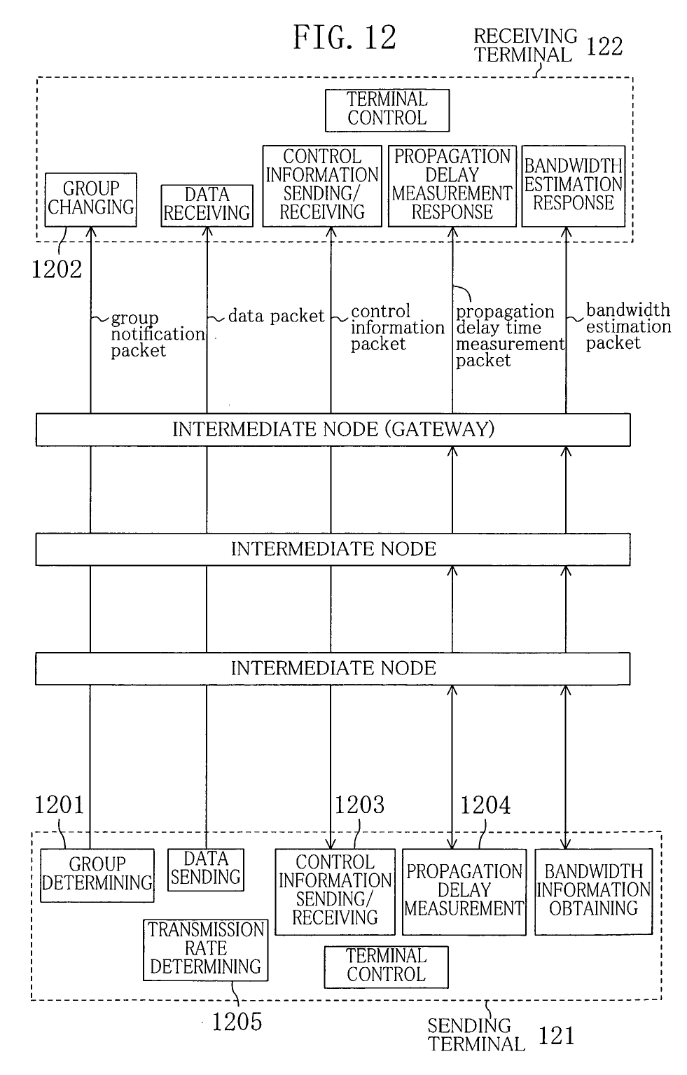

FIG. 12 is a schematic drawing illustrating the overall configuration of the present embodiment. Except for a group determining portion 1201, a sending terminal 121 is equal to the sending terminal 10 of FIG. 1. Except for a group changing portion 1202, a receiving terminal 122, is equal to the receiving terminal 11 of FIG. 1.

The group determining portion 1201 is a means for grouping the receiving terminals 122 based on at least one of the statistical information such as the RTT, packet loss, and jitter observed by a control information sending/receiving portion 1203, the RTT to and from each of the intermediate nodes (including the plurality of gateways) which is observed by a propagation delay measurement portion 1204, and the transmission rate determined by a transmission rate determining portion 1205, and notifies the receiving terminals 122 of the groups to which they belong.

The group changing portion 1202 is a means for changing the assigned group to the notified group when the group notified from the sending terminal 121 is different from the currently assigned group.

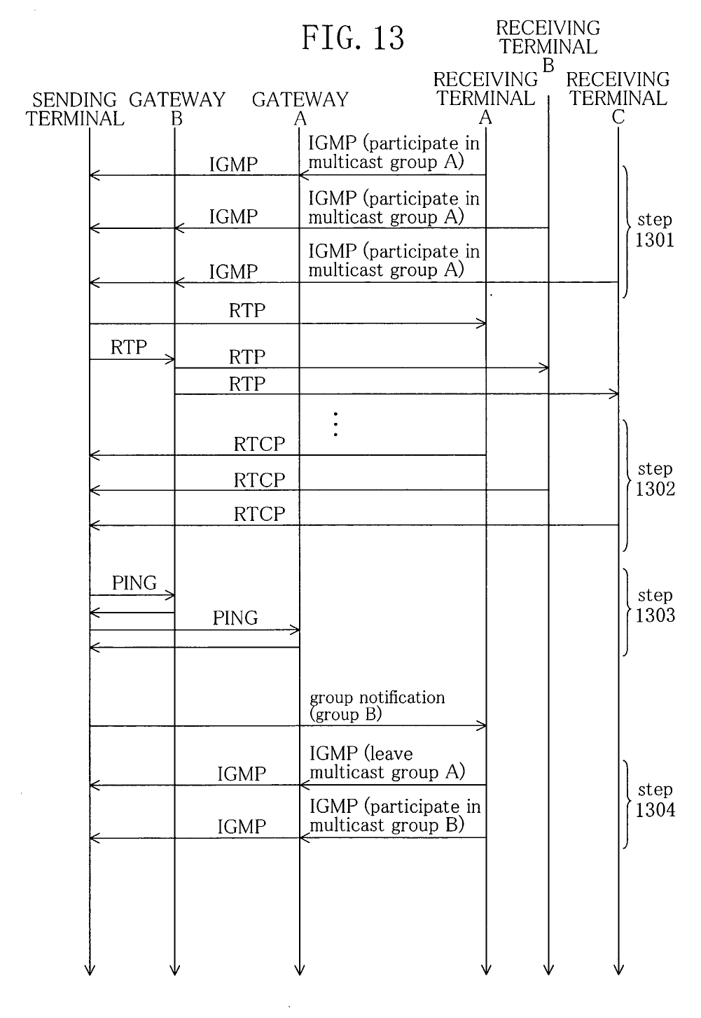

FIG. 13 is a sequence diagram representing the operation of the present embodiment. In this example, a receiving terminal A has been connected to a gateway A, and receiving terminals B and C have been connected to a gateway B.

When starting the reception of video by multicasting, the receiving terminals A, B, and C use an IGMP (Internet Group Management Protocol) to participate in a specific multicast group (step 1301). In this example, the receiving terminals initially participate in Group A. The sending terminal 121 can ascertain that the receiving terminals have participated in a multicast group by the control information packets from the receiving terminals (step 1302). The sending terminal 121 also sends RTT observation packets to links that may become a bottleneck link on the transmission paths to the receiving terminals, and determines the RTT (step 1303). Using the RTT and other information obtained from the control information packets such as the RTT, packet loss, and jitter between itself and the receiving terminals, the sending terminal 121 determines the groups to which the terminals belong and notifies them to the receiving terminals (step 1304). In this example, a notification is sent for changing the receiving terminal A to group B. The receiving terminal A leaves group A and then joins group B, because the group it currently belongs to is different from the group notified from the sending terminal 121 (step 1304).

It should be noted that the transmission rate when sending data to the multicast groups is the average value of the transmission rate for the receiving terminals belonging to that particular multicast group (which can be calculated with the method disclosed in the first or second embodiment). Since receiving terminals with similar tendencies for transmission rate change are combined into the same group as explained below, even the simple method for transmission rate control described above enables a transmission rate that is for the most part satisfactory for the receiving terminals participating in that multicast group.

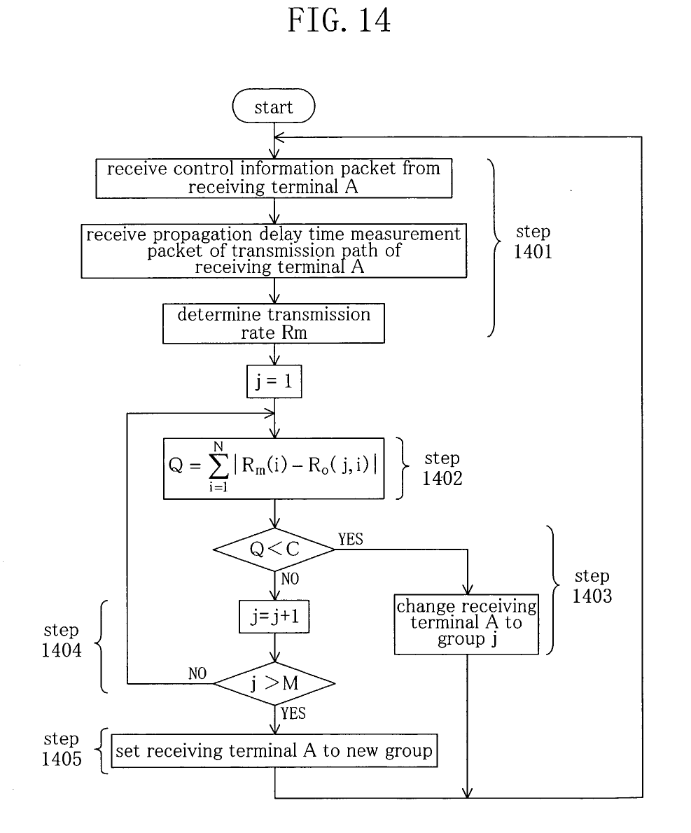

FIG. 14 is a flowchart showing how the group determining portion 1201 operates. First, it receives control information packets from the receiving terminal A and RTT observation packets from intermediate nodes on the transmission path to the receiving terminal A, and determines the transmission rate Rm in accordance with the method for transmission rate control described in the first or second embodiment (step 1401). Next, the difference Q in the transmission rates is calculated from the transmission rates Rm(i) (1≦i≦N) calculated for the past N times for the receiving terminal A, and the transmission rates Ro(j,i) calculated for the past N times for the multicast group j (1≦i≦M, where M is the number of multicast groups managed by the sending terminal 121) (step 1402). If Q is smaller than a certain threshold value C, then the tendency of the transmission rate change is determined to be similar, and the receiving terminal A is changed to the multicast group j (step 1403). If Q is larger than C, then the tendency of the transmission rate change is regarded as different, and the receiving terminal A is not included in the multicast group j (step 1404). The steps 1403 and 1404 are repeated until the receiving terminal A is sorted into one of the multicast groups or until the tendency of the change in the transmission rate has been compared to all of the multicast groups. If no multicast group satisfies Q<C even after the tendency of the change in transmission rate has been compared to all multicast groups, then a new multicast group is created and the receiving terminal A is changed to that group (step 1405).

In the present embodiment, as the method for grouping, terminals with similar tendencies in the fluctuations of the transmission rate can be grouped together, but it is also possible to simply regard the receiving terminals connected to the same gateway as a single group. Furthermore, grouping can also be carried out not using the tendency of the fluctuations in transmission rate but grouping terminals together that have similar tendencies for packet loss or fluctuations of the RTT.

Moreover, in the present embodiment, the RTT between the sending terminal 121 and the intermediate nodes is used to determine the transmission rate, but as was mentioned in the explanation of FIG. 3, it is also possible to determine the transmission rate in accordance with fluctuation in RTT between the intermediate nodes or the packet loss at the intermediate nodes, and carry out the grouping based on the determined transmission rate.

Furthermore, it is also possible to measure at least one of the RTT, packet loss, and jitter, for example, between the sending terminal 121 and the receiving terminals and calculate the variation width or period of change thereof, to determine whether the network is in a state in which congestion is occurring or in a state in which handover or transmission errors are occurring, and if it is determined to be the former, the sending terminal 121 can perform grouping as described earlier in accordance with the state of the congestion.

In the present embodiment, grouping was performed using a method in which the sending terminal 121 determines which group the receiving terminals should belong to and the receiving terminals follow these instructions, but it is also possible that the receiving terminals have group determining portions 1201 to permit grouping performed from the receiving terminals. For example, in the case of a configuration in which the group determining portion 1201 is added to the receiving terminal 61 of the configuration shown in FIG. 6, the receiving terminal can directly carry out grouping by using a method in which the sending terminal 60 sends to the receiving terminal 61 data information sets of transmission rate that can be sent and multicast address, and the multicast group the receiving terminal 61 participates in is changed in accordance with the transmission rate that is determined by the transmission rate determining portion 608.

Furthermore, in the present embodiment, if AV transmission using hierarchical encoding is possible, the receiving terminal is able to determine the level to use in accordance with the state of congestion. For example, if the degree of congestion is severe, it is possible to use only the lowest level.

As explained above, with the first through third embodiments, it is possible to conduct suitable transmission rate control, even in a network such as the Internet with connections in various connection modes, by performing transmission rate control taking into consideration the sending and receiving of data at the intermediate nodes. In particular, appropriate transmission rate control can be carried out for applications such as TV telephone and Video on Demand, regardless of whether the communication is one-to-one or one-to-many (multicast), over connection modes in which there is a mixture of wireless networks such as wireless LAN, DSRC, W-CDMA, and FWA, and wired networks such as an Ethernet and ATM, in which suitable transmission rate control was conventionally difficult to perform.

Fourth Embodiment

The present embodiment relates to a method for changing the target value in accordance with the state of an intermediate node when attempting to let the amount of residual data that is residual in the intermediate node be close to the target value, and is primarily for solving the aforementioned third problem.

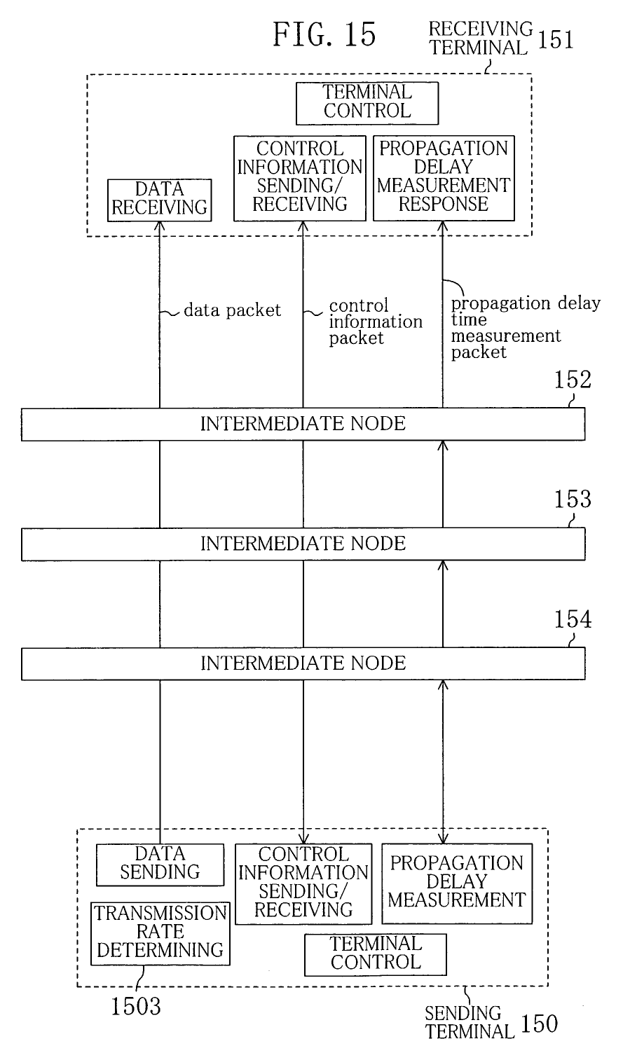

FIG. 15 is a schematic drawing representing the overall configuration according to the present embodiment. In FIG. 15, a sending terminal 150 corresponds to the sending terminal 10 of FIG. 1 without the bandwidth information obtaining portion 103. A receiving terminal 151 corresponds to the receiving terminal 11 of FIG. 1 without the bandwidth estimation response portion 113. Intermediate nodes 152, 153, and 154 are equivalent to the intermediate nodes 12 to 14 of FIG. 1.

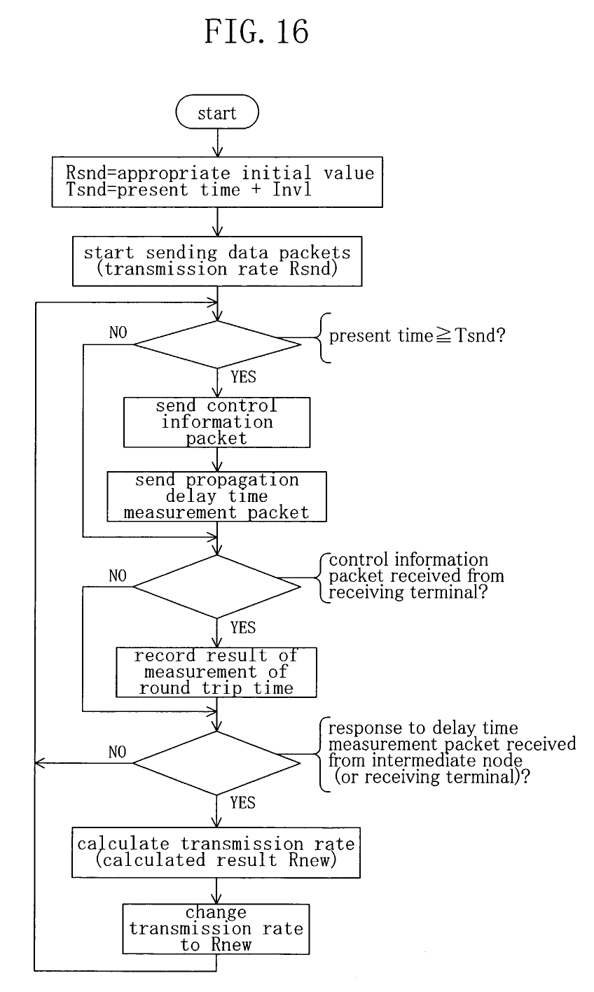

FIG. 16 is a flowchart illustrating the operation of the sending terminal 150 according to the present embodiment. Apart from the changes of removing the step for obtaining bandwidth information (step 200) and setting the initial value of the transmission rate to an appropriate value, FIG. 16 is not different from FIG. 2, and therefore step numbers have been omitted.

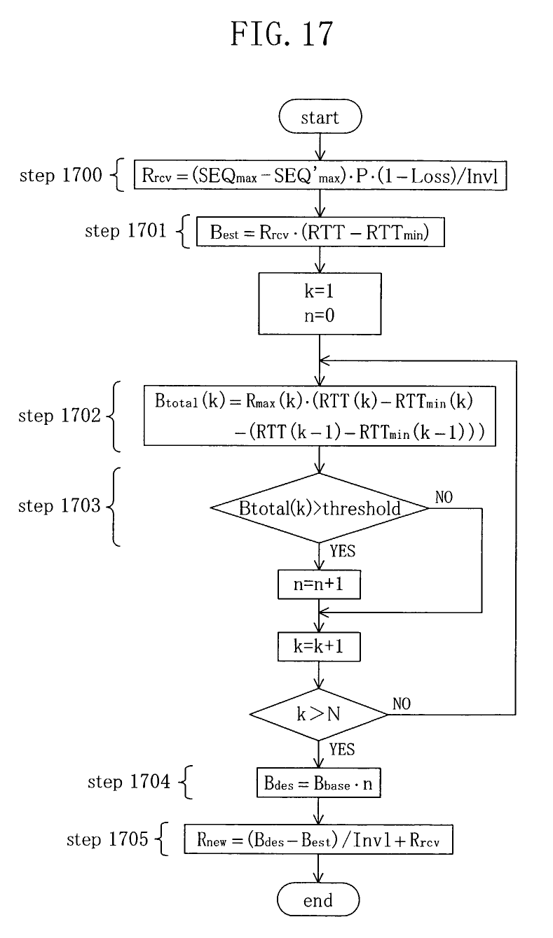

FIG. 17 is a flowchart illustrating the operation of the steps for determining the transmission rate in FIG. 16. This operation is performed by a transmission rate determining portion 1503 in the sending terminal 150. First, the reception rate R_{rcv} of the receiving terminal 151 is calculated (step 1700). If the control information is sent using RTCP, then R_{rcv} can be calculated by using the maximum sequence number SEQₘₐₓ, the packet loss rate Loss, and the send interval Invl between control information packets. SEQ′ₘₐₓ is the maximum sequence number notified by the previous RTCP packet.

Next, the data amount Best that is residual on the transmission path between the sending terminal 150 and the receiving terminal 151 is calculated using the RTT between the sending terminal 150 and the receiving terminal 151 as well as the R_{rcv} (step 1701). Here, RTTₘᵢₙ represents the lowest value of the RTTs measured between the sending terminal 150 and the receiving terminal 151 up to that point.

Next, the total data amount Bₜₒₜₐₗ(k), which includes other flows residual in the Node(k), is estimated from the round trip times RTT(k) and RTT(k−1) between the sending terminal 150 and the Nodes(k) and (k−1), and the link bandwidth Rₘₐₓ(k) of the Node(k) (step 1702). Here, RTTₘᵢₙ(k) represents the lowest value of the RTT measured between the sending terminal 150 and the Node(k) up to that point. If the data amount Bₜₒₜₐₗ(k) is larger that the threshold value, then it is determined that data packets are residual in the Node(k), and if it is smaller than the threshold value, then it is determined that no data packets are residual in the Node(k) (step 1703).

Depending on this assessment, the number n of intermediate nodes regarded as having residual data packets is counted and the target data amount B_{des} is calculated from the basic target data amount B_{base} and n (step 1704). Lastly, the next transmission rate R_{new} is determined such that the amount of residual data during the send time interval Invl of the control information from the receiving terminal 151 reaches B_{des} (step 1705).

In step 1704, the target data amount was calculated using B_{base} and n, but it is also possible to calculate it with the packet loss rate Loss by B_{des}=B_{base}×(1−Loss).

Fifth Embodiment

The present embodiment relates to a scheme for switching the method for determining the transmission rate based on whether or not packet loss is occurring, and is primarily for solving the aforementioned fourth problem.

A schematic view representing the entire configuration of the present embodiment is equivalent to that of FIG. 1. Also, the flowchart illustrating the operation of the sending terminal according to the present embodiment is equivalent to that of FIG. 2.

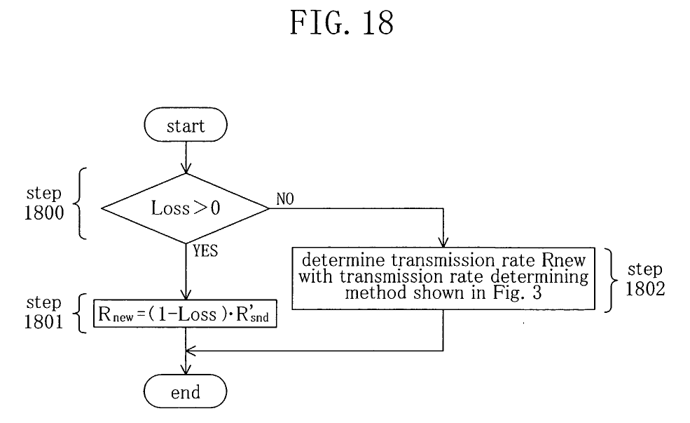

FIG. 18 is a flowchart representing the operation of the step for determining the transmission rate (step 205 in FIG. 2) according to the present embodiment. First, whether packet loss is occurring is assessed based on the packet loss rate Loss of the control information packets (step 1800). If it is determined that there is packet loss, then the next transmission rate R_{new} is determined based on the packet loss rate Loss and the previous transmission rate R′_{snd} (step 1801). It should be noted that apart from the method illustrated in step 1801, it is also possible to have R_{snd}=R′_{snd}×(constant)(where the constant is a real number of at least 0 and at most 1) based on the previous transmission rate, or to use a rate control method based on the packet loss, such as DAA or LDA. When there is no packet loss, the method shown in FIG. 3 is used to determine the transmission rate R_{new} (step 1802). In step 1802, apart from the method shown in FIG. 3 it is also possible to use the method shown in FIG. 17, for example.

In step 1800, it is also possible to switch the transmission rate control method based on the transmission path or the delivery scheme currently in use, instead of switching the transmission rate control method depending on whether there is packet loss. This means that it is possible to have step 1801 performed in the case of Ethernet or multicasts, and step 1802 performed when using a transmission path with a large bandwidth gap for one-to-one communication.

Sixth Embodiment

The present embodiment relates to a bandwidth estimation method in which bandwidth estimation is performed using the control information channel and the data channel, and is primarily for solving the second problem mentioned above.

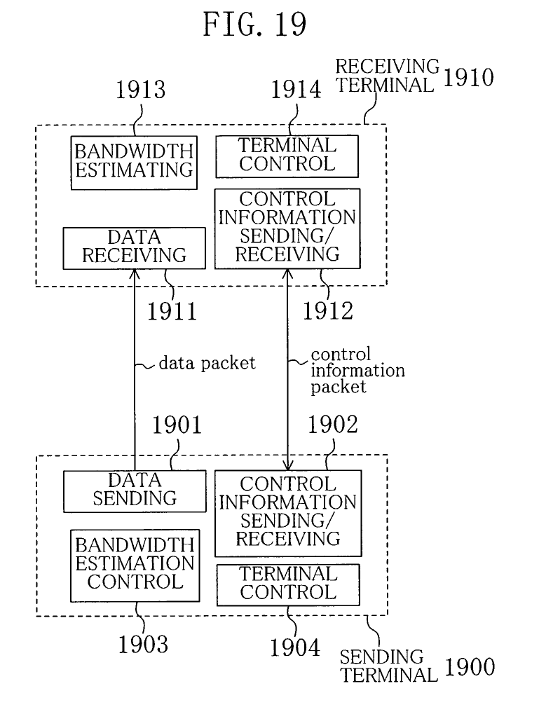

FIG. 19 is a schematic drawing showing the entire configuration according to the present embodiment. In a sending terminal 1900, a data sending portion 1901 is a means for taking in data from inputs such as a capture, a microphone, or a file, encoding the data if necessary, packetizing the data if necessary, and sending data packets to a receiving terminal 1910. Additionally, it is also a means for consecutively sending data packets without a send interval between the packets at the command of a bandwidth estimation control portion 1903. It is presumed that a data transmission protocol such as RTP is used as the protocol for data transmission.

A control information sending/receiving portion 1902 is a means for exchanging with the receiving terminal 1910 control information pertaining to data packets sent from the sending terminal 1900. Control information sent from the sending terminal 1900 to the receiving terminal 1910 includes information showing which data packets were sent for bandwidth estimation, and the information delivered from the receiving terminal 1910 to the sending terminal 1900 includes the results of the bandwidth estimation. As the protocol for transmission of the control information, it is possible to use TCP, but it is also possible to expand a data transmission control protocol such as RTCP.

The bandwidth estimation control portion 1903 is a means for instructing the data sending portion 1901 to consecutively send data packets for bandwidth estimation without a send interval between the packets. It is also a means for notifying the control information sending/receiving portion 1902 of the packets sent for bandwidth estimation (for example, the sequence number of the first and the last of the packets sent without a send interval if the data packets are sent using RTP).

A terminal control portion 1904 is a means for controlling the various portions of the sending terminal 1900.

In the receiving terminal 1910, a data receiving portion 1911 is a means for receiving data packets sent from the sending terminal 1900, unpacking the packets if necessary, decoding the packets if necessary, and delivering the data to an output such as a monitor, a speaker, or a file.

A control information sending/receiving portion 1912 is a means for sending/receiving control information regarding the sent data packets to and from the sending terminal 1900.

A bandwidth estimating portion 1913 is a means for measuring the interval of the arrival of bandwidth estimation packets based on information indicating the bandwidth estimation packets which are received by the control information sending/receiving portion 1912. It is also a means for estimating the transmission bandwidth based on this arrival interval, and notifying the results to the control information sending/receiving portion 1912.

A terminal control portion 1914 is a means for controlling the various portions of the receiving terminal 1910.

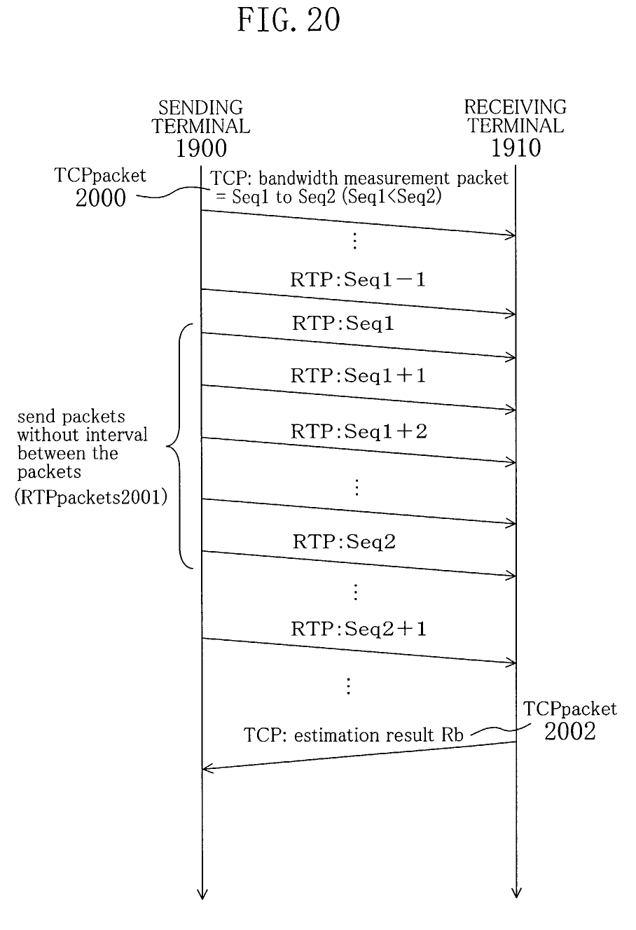

FIG. 20 is a sequence diagram between the sending terminal 1900 and the receiving terminal 1910 when bandwidth estimation is performed in a case in which TCP is used as the protocol for control information transmission and RTP is used as the protocol for transmission of the data packets.

The sending terminal 1900 first sends a control information packet for indicating which data packets are for bandwidth estimation (TCP packet 2000). In FIG. 20, the data packets that are used are those between Seq1 and Seq2. Then, data packets for bandwidth estimation are sent consecutively at a specific time interval (RTP packets 2001). The specific time interval should be set to an interval that is short enough that on the transmission path other packets are not interspersed between the packets for bandwidth estimation (naturally, this includes zero seconds). The receiving terminal 1910 measures the arrival interval delta of the bandwidth estimation packets that are notified from the sending terminal 1900, and in accordance with this measurement estimates the bandwidth of the bottleneck link R_{b}=P/(average value of delta), wherein P is the packet size of the data packets. The receiving terminal 1910 sends the results of the measurement using a control information packet (TCP packet 2002).

Seventh Embodiment

The present embodiment pertains to a bandwidth estimation scheme in which the data packets are given a bandwidth estimation flag, and is primarily for solving the above mentioned second problem.

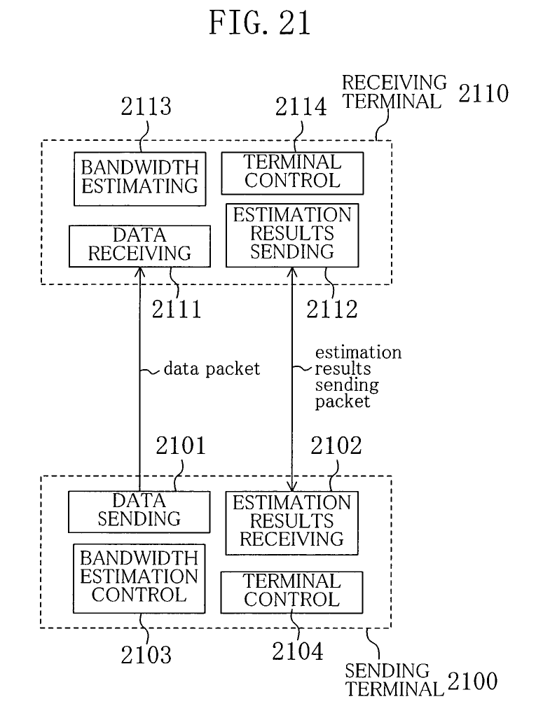

FIG. 21 is a schematic drawing representing the overall configuration according to the present embodiment. In a sending terminal 2100, a data sending portion 2101 is a means for taking data from an input such as a capture, a microphone, or a file, encoding the data if necessary, packetizing the data if necessary, and transmitting the data packets to a receiving terminal 2110. It is also a means for consecutively sending data packets without a send interval between the packets as instructed by a bandwidth estimation control portion 2103. Furthermore, it is also a means for setting a bandwidth estimation flag to data packets sent as bandwidth estimation packets so as to indicate that they are bandwidth estimation packets. It is presumed that a data transmission protocol such as RTP is used as the protocol for the transmission of data. For the bandwidth estimation flag, it is possible to use an existing field in the data packet header, such as the marker bit field of RTP or the extension bit field, or to extend the RTP packets to define a new field, or to input the flag into the payload. It is possible to set the bandwidth estimation flag in all of the packets that are sent as bandwidth estimation packets, or to set it in only the first and last of the packets that are sent as bandwidth estimation packets.

An estimation results receiving portion 2102 is a means for receiving the results of the bandwidth estimation from the receiving terminal 2110. It is assumed that the protocol for sending/receiving the estimation results is a data transmission control protocol such as RTCP.

A bandwidth estimation control portion 2103 is a means for instructing the data sending portion 2101 to consecutively transmit, without packet intervals, data packets serving as bandwidth estimation packets.

A terminal control portion 2104 is a means for controlling the various portions of the sending terminal 2100.

In the receiving terminal 2110, a data receiving portion 2111 is a means for receiving data packets sent from the sending terminal 2100, unpacking the packets if necessary, decoding if necessary, and delivering the data to an output such as a monitor, a speaker, or a file.

An estimation results sending portion 2112 is a means for sending the bandwidth of the bottleneck link that has been estimated by a bandwidth estimating portion 2113 to the sending terminal 2100. It is assumed that the protocol for sending/receiving the estimation results is a data transmission control protocol such as RTCP.

The bandwidth estimating portion 2113 is a means for checking the bandwidth estimation flag of the data packets. Additionally, when the bandwidth estimation flag is set, it is also a means for measuring the arrival interval delta of the data packets, and in accordance with those results estimating the bandwidth of the bottleneck link, R_{b}=P/(average value of delta), where P is the packet size of the data packets, and notifying the results of the estimation to the estimation results sending portion 2112. At this time, if packet loss due to jumps in the sequence number Seq of the RTP packets is detected, the arrival interval delta between the sequence numbers Seq−1 and Seq+1 are not included in the results of the measurement. This is to eliminate errors in the estimation caused by packet loss.

A terminal control portion 2114 is a means for controlling the various portions of the receiving terminal 2110.

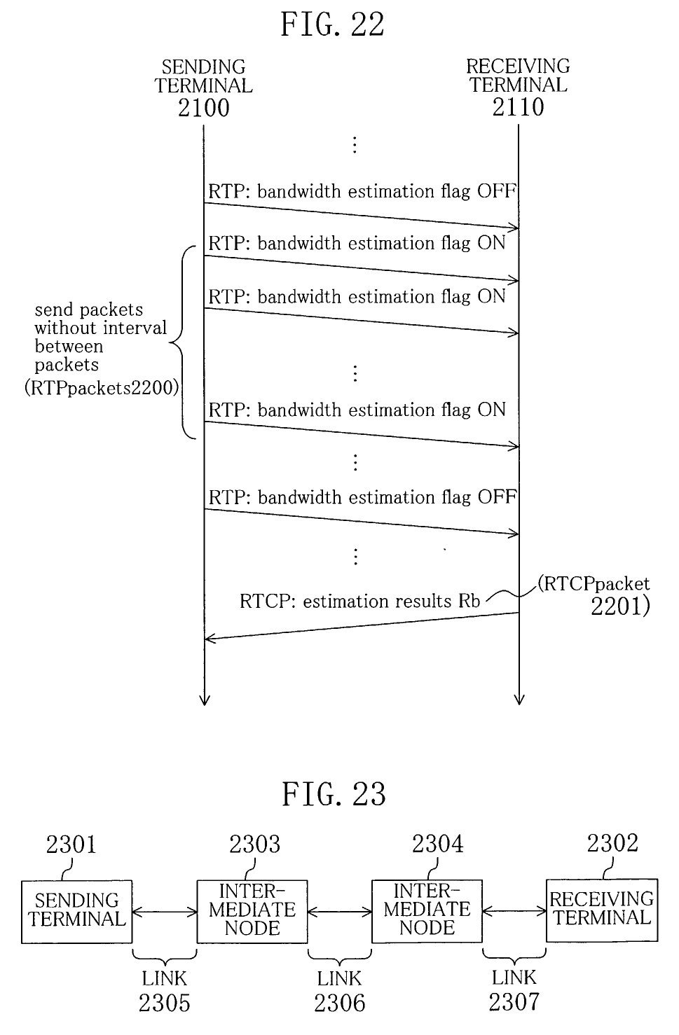

FIG. 22 is a sequence diagram between the sending terminal 2100 and the receiving terminal 2110 when bandwidth estimation is performed in a case in which RTP is used for sending data packets and RTCP is used for sending the estimation results. First, the sending terminal 2100 sends data packets without a send interval as packets for bandwidth estimation (RTP packets 2200). At this time, the bandwidth estimation flag for indicating that a packet is for bandwidth estimation is set in the data packets. The receiving terminal 2110 receives the data packets and checks the bandwidth estimation flag in the data packets. If the bandwidth estimation flag has been set, then the receiving terminal 2110 measures the arrival interval of the packets and with those results estimates the bandwidth of the bottleneck link. The receiving terminal 2110 sends the results of this estimation to the sending terminal 2100 (RTCP packet 2201).

It should be noted that in the present embodiment, if one wishes to estimate the bandwidth Rb of the bottleneck link before sending the data packets, or if one does not wish to use the data packets as bandwidth estimation packets, it is also possible to send data packets not including data in their payload as bandwidth measurement packets, to measure only the arrival interval of these bandwidth estimation packets at the receiving terminal 2110, and then discard the packets.

Additionally, in the present embodiment it is also possible to use a bandwidth estimation sequence number representing the number of sent bandwidth estimation packets instead of a bandwidth estimation flag. In this situation, the arrival interval is not measured if the bandwidth estimation sequence number is 0, and the arrival interval is measured if that number is other than 0. Moreover, packet loss can be detected by jumps in the bandwidth estimation sequence number, and by not using the packets before and after a lost packet to measure the arrival interval it is possible to eliminate errors in the estimation due to packet loss.

Eighth Embodiment

The present embodiment relates to a bandwidth estimation method with end conditions, and is primarily for solving the aforementioned first problem.

FIG. 23 is a schematic drawing illustrating the overall configuration according to the present embodiment. In FIG. 23, a sending terminal 2301 sends packets for bandwidth estimation to intermediate nodes 2303 and 2304 on the route to a receiving terminal 2302. The packets for bandwidth estimation are for measuring the RTT between the sending terminal 2301 and the intermediate nodes 2303 and 2304 on the route. For example, if the network is an IP network, sending an IP packet in which the TTL field is set to n permits the transmission of a TTL expired message with an ICMP packet to the n-th intermediate node on the route, and thereby permits measurement of the RTT to and from the intermediate nodes.

The receiving terminal 2302 sends a response to the packets for bandwidth estimation that have been sent from the sending terminal 2301. For example, if the network is an IP network, the receiving terminal 2302 sends response PING packets with respect to PING packets from the sending terminal 2301. The receiving terminal 2302 is the end of the route for which the sending terminal 2301 measures the bandwidth.

The intermediate nodes 2303 and 2304 send a response to the packets for bandwidth estimation that have been sent from the sending terminal 2301. For example, if the network is an IP network, when the sending terminal 2301 sends IP packets in which the TTL field has been set to n, the n-th node on the route sends a TTL Expired message with ICMP packets to the sending terminal 2301.

Links 2305, 2306, and 2307 are networks such as an Ethernet or SLIP (Serial Line Internet Protocol) connecting the sending terminal 2301, the receiving terminal 2302, and the intermediate nodes 2303 and 2304. In the present embodiment, the bandwidth of these links is measured.

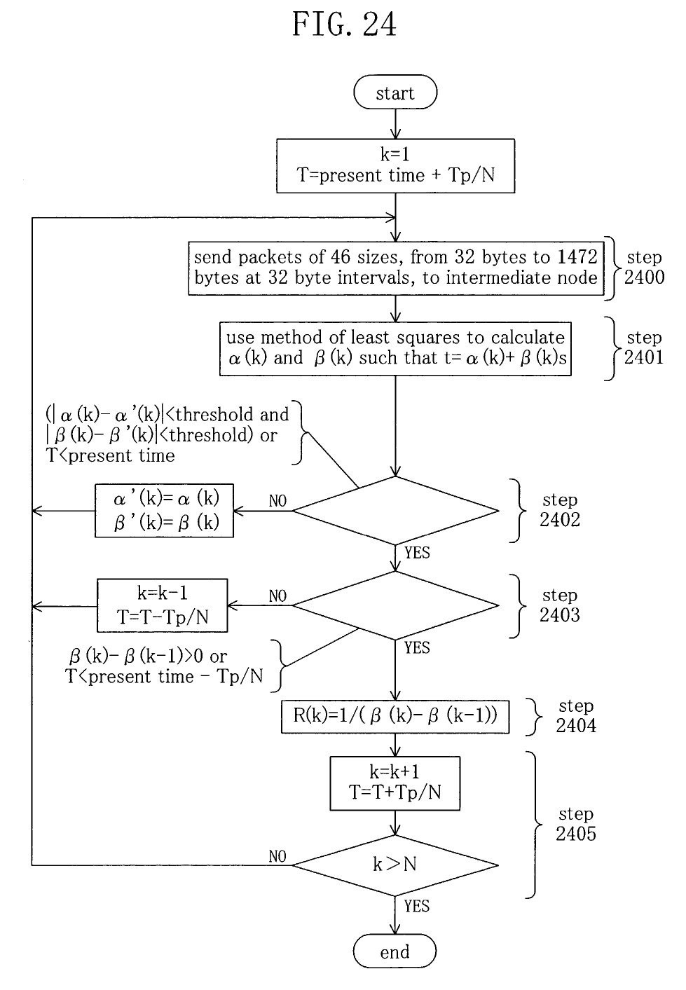

FIG. 24 is a flowchart illustrating the operation of the sending terminal 2301 when performing bandwidth estimation. The sending terminal 2301 estimates the bandwidth of the links in order from the link closest to the sending terminal 2301. Specifying the measurement time Tₚ of all the links and assuming that there are N links between the sending terminal 2301 and the receiving terminal 2302, the bandwidth of the k-th link from the sending terminal is estimated as follows.

First, packets of 46 sizes at 32 byte intervals from 32 bytes to 1472 bytes are sent to the intermediate node 2303 (step 2400). Next, when s is the packet size, and t is the minimum RTT, α(k) and β(k) are determined using the method of least squares such that

t=α(k)+β(k)s

(step 2401). It should be noted that to obtain more precise results with fewer measured points, it is also possible to use another statistical process such as M estimation or weighted least squares.

The results of the calculation of α(k) and β(k) are compared with α′(k) and β′(k), which have been obtained from the results of the previous trial, and if the change is within the range of the threshold value, the results are determined to be convergent. However, also if the estimation end time T of the k-th node has passed, then the results are determined to be convergent. The estimation end time of the k-th node is given as (estimation start time)+k×Tp/N (step 2402).

If it is determined that the results are not convergent, then the steps 2400 and 2401 are repeated one more time. For determining convergence, it is also possible to compare to a plurality of past trial results, instead of to only the previous trial results, to determine whether the change is within the range of the threshold value.

In step 2402, if it has been determined that α(k) and β(k) are convergent, then β(k) and β(k−1) are compared. If β(k) is smaller than β(k−1) then the estimated bandwidth becomes negative, and therefore this means that there is an error in one of either β(k−1) or (k). To correct this error, if measurement time is remaining, then the procedure returns to the previous hop and the measurement is redone (step 2403).

If β(k) is larger than β(k−1) or if the measurement time has expired, then it is determined that the measurement was correct and the bandwidth of the link is determined (step 2404). Then, if there is a next hop, then the sending terminal 2301 proceeds to bandwidth estimation of the next hop, and the process is finished when the final hop has been reached (step 2405).

Ninth Embodiment

The present embodiment relates to a method for ensuring the quality of the transmission by securing a minimum bandwidth at an intermediate node (for example a router or a gateway), and is primarily for solving the aforementioned sixth problem.

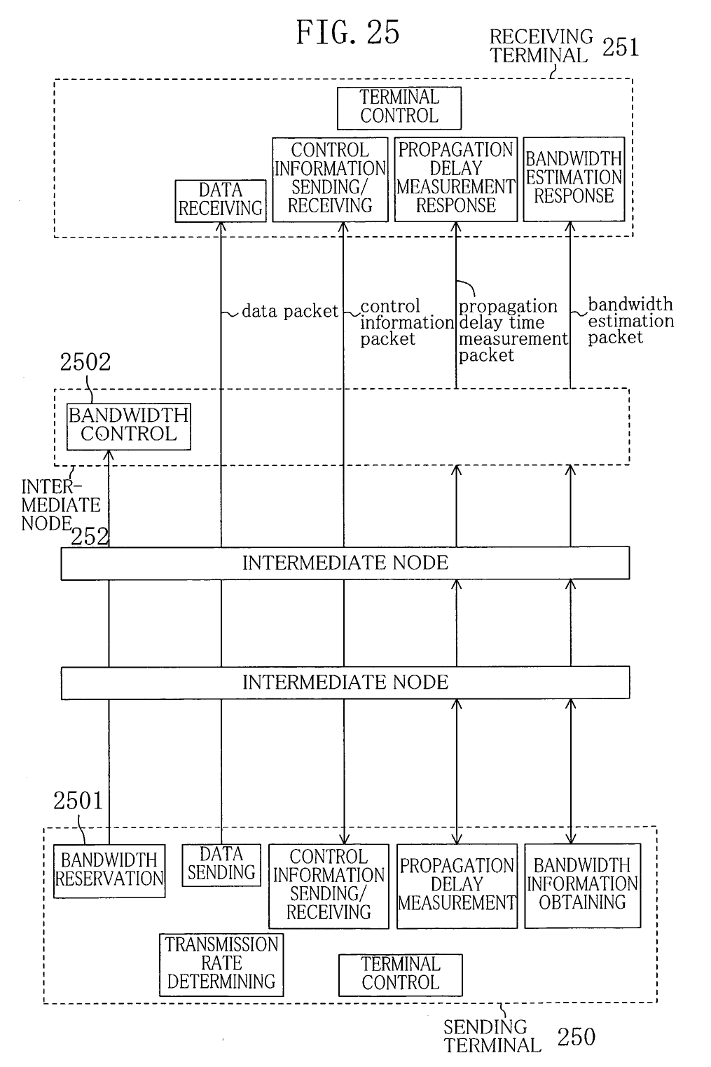

FIG. 25 is a schematic drawing representing the overall configuration according to the present embodiment. A sending terminal 250 is a sending terminal in which a bandwidth reserving portion 2501 has been added to the sending terminal 10 shown in FIG. 1. An intermediate node 252 interposed between the sending terminal 250 and a receiving terminal 251 is an intermediate node in which a bandwidth control portion 2502 has been added to the intermediate node 12 shown in FIG. 1.

The bandwidth reserving portion 2501 is a means for notifying the intermediate node 252 of the minimum transmission rate and the maximum transmission rate that can be sent by the sending terminal 250. Additionally, it is also a means for receiving the results of whether bandwidth can be ensured at the notified transmission rate.

The bandwidth control portion 2502 is a means for reserving the transmission bandwidth at the lowest transmission rate notified from the sending terminal 250. Moreover, it is also a means for notifying the sending terminal 250 that the transmission bandwidth cannot be ensured in a case in where the transmission bandwidth reservation is impossible.

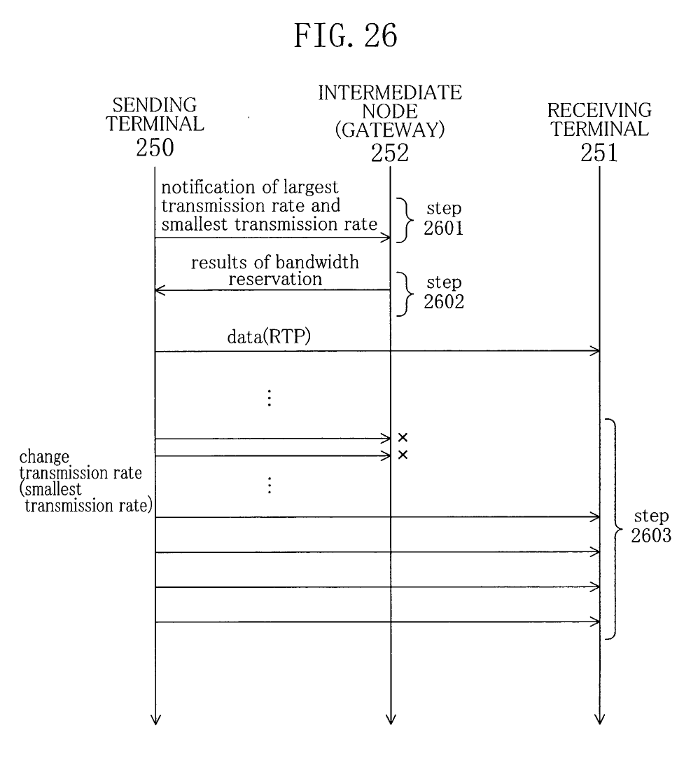

FIG. 26 is a sequence diagram illustrating how the present embodiment operates. Before transmitting data, the sending terminal 250 notifies the intermediate node 252 of the smallest transmission rate and the largest transmission rate that can be sent by the sending terminal 250 (step 2601). The intermediate node 252 reserves transmission bandwidth at the notified transmission rates and notifies the sending terminal 250 that the reservation has been made (step 2602). The sending terminal 250 confirms that the transmission bandwidth has been reserved, and starts the transmission of data. At this time, the sending terminal 250 determines the transmission rate with the method described in either the first or second embodiment from the control information packets or the RTT between itself and the intermediate node 252, for example, and transmits data at the determined transmission rate. If there is exceptionally severe congestion and the transmission rate decreases to its minimum value, then, it is possible to ensure a minimum transmission quality, because the transmission bandwidth has been reserved with the intermediate node 252 (that is, due to the bandwidth reservation, packet loss does not occur), and video without disturbances or audio transmission with few breaks can be achieved (step 2603).

It should be noted that in the present embodiment, the sending terminal 250 reserved the transmission bandwidth by notifying the required transmission bandwidth, but the present invention can also be worked without the transmission bandwidth being notified from the sending terminal 250. For example, it is also possible to apply the present invention when the minimum transmission rate of the sending terminal 250 has been determined and the administrator establishes the reserved bandwidth at the intermediate terminal 252 in advance. Furthermore, the present invention can also be applied when the transmission bandwidth that can be used for the transmission of data by the intermediate node 252 is reserved, the reserved bandwidth is notified to the sending terminal 250, and the sending terminal 250 determines the transmission rate in accordance with that reserved transmission bandwidth. Here, the transmission bandwidth that can be used for the transmission of data by the intermediate node 252 can also be based on the type of data that is sent by the intermediate node 252.

It is moreover possible that the receiving terminal 251 notifies the intermediate node 252 of the minimum transmission rate requested of the sending terminal 250, and the intermediate node 252 performs reservation. This reservation method is effective for reflecting the minimum video quality requested by the receiving terminal 251 in the transmission.

Additionally, the receiving terminal 251 buffers data every several seconds so as to absorb fluctuations in the network before reproducing data, and by letting the receiving terminal 251 have a minimal buffer of (buffering time)×(minimum transmission rate), it is possible to achieve video without disturbances or audio transmission with few breaks.

Tenth Embodiment

The present embodiment relates to a method for ensuring video quality by prioritizing the transmission of control packets, and is primarily for solving the aforementioned seventh problem.

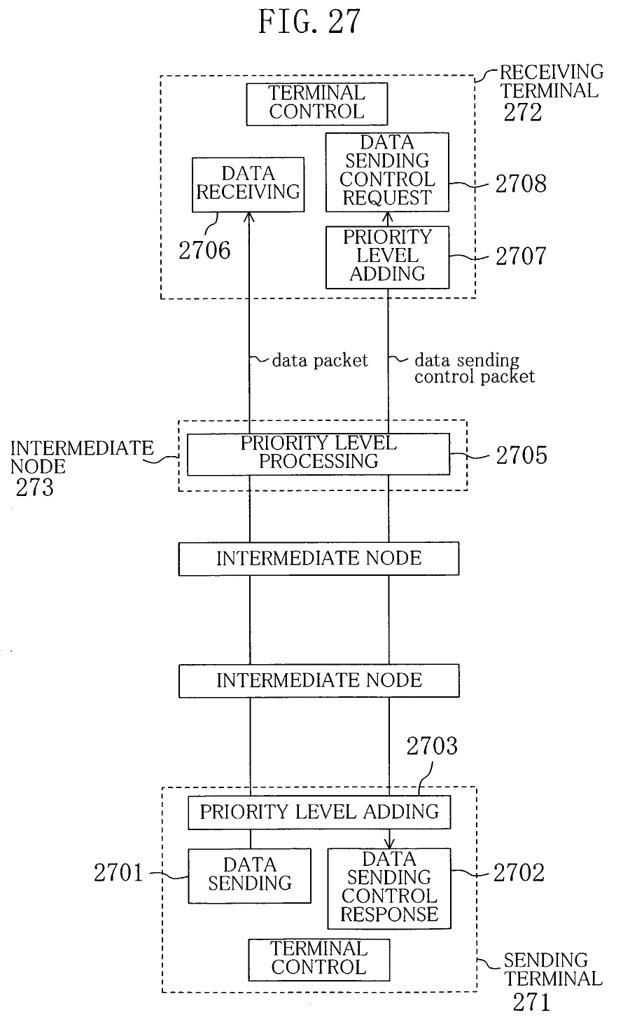

FIG. 27 is a schematic view illustrating the overall configuration according to the present embodiment. In a sending terminal 271, a data sending portion 2701 and a data transmission control response portion 2702 are equivalent to the data sending portion 601 and the data transmission control response portion 602, respectively, shown in FIG. 6. In a receiving terminal 272, a data receiving portion 2706 and a data sending control request portion 2708 are equivalent to the data receiving portion 605 and the data sending control request portion 606, respectively, depicted in FIG. 6.

In FIG. 27, priority level adding portions 2703 and 2707 are means for adding, to the packets sent across the network, a high priority level to control packets and a low priority level to data packets. An example of a method for adding priority level is to enter priority level information into the TOS field of IP packets.

A priority level processing portion 2705 disposed in an intermediate node 273 is a means for priority processing packets assigned a high priority level. With the priority level processing portion 2705, packets assigned a high priority level are discarded at a low rate and transmitted with low latency to the receiving terminal 272. DiffServ can be used as the method for priority level processing.

The above configuration permits the low latency and lossless transmission of control packets and enables the transmission of data packets to be started and stopped reliably and with low latency, even when there is congestion.

It should be noted that applying the above configuration to TCP makes it possible for TCP sessions to be established and disconnected reliably and with low latency. For example, setting the priority level such that control packets (SYN, PIN packets) are discarded at a low rate enables the reliable and low latency establishment and disconnection of the TCP session.

Of course, this method can be applied not only in one-to-one communication between a terminal and a server but also in one-to-many communication (multicast) in which broadcasts are made to a plurality of terminals.

The first through tenth embodiments according to the present invention are as explained above, but it goes without saying that the present invention also encompasses a sending device, a receiving device, and a sending/receiving system provided with these for realizing the data sending/receiving method of the present invention.

The present invention can be a program for executing with a computer the functions of some or all of the means (or devices, elements, circuits, parts, etc.) of the above-mentioned sending device, the receiving device, and sending/receiving system according to the present invention, which operates in cooperation with a computer. It should be noted that a computer according to the present invention is not limited to pure hardware such as a CPU, and can also include firmware or an OS (operating system), as well as peripheral devices.

The present invention also can be a program for executing with a computer the operations of some or all of the steps (or processes, operations, actions, etc.) of the data sending/receiving method according to the present invention, in cooperation with a computer.

Furthermore, a computer-readable storage medium onto which the program of the present invention is stored is also encompassed by the present invention. Also, one mode for the use of the program according to the present invention is to store it on a computer-readable storage medium and to operate it in cooperation with the computer to operate. A further mode for the use of the program according to the present invention is to transmit it through a transmission medium, read it with by a computer and then operate it in cooperation with the computer. Furthermore, examples of the storage medium include ROM (Read Only Memory), and examples of the transmission medium include transmission media such as the Internet, as well as light, electromagnetic waves, and acoustic waves.

The configuration of the present invention can be achieved by software or hardware.

### INDUSTRIAL APPLICABILITY

With the present invention, it is possible to perform an efficient transmission of data with a stable transmission quality over a transmission path like the Internet in which there are various connection modes and fluctuations in the transmission bandwidth. In particular, by applying the present invention to connection modes with mixed wired networks and wireless networks, in which it has conventionally been difficult to perform data transmission with a stable transmission quality, it becomes possible to perform an efficient transmission of data with a stable transmission quality in a wide array of applications, such as Internet TV telephone, VoD, broadcasts (multicasts), and video billboards.

1. A data sending/receiving method, wherein a transmission rate from a sending terminal is determined in accordance with a state of receiving and/or sending of data in all or a portion of intermediate nodes provided on a transmission path between the sending terminal and a receiving terminal.

2. The data sending/receiving method according to claim 1, wherein the transmission rate from the sending terminal is determined in accordance with at least one of a round trip time between all or a portion of the intermediate nodes and the sending terminal, fluctuation in the round trip time, packet loss at the intermediate nodes, a bandwidth of a link of the intermediate nodes, and past transmission rates.

3. The data sending/receiving method according to claim 2, wherein, for obtaining at least one information of the round trip time, the fluctuation in the round trip time, and the packet loss at the intermediate nodes with sending terminals, the sending terminals capable of obtaining the information are restricted by the intermediate nodes.

4. The data sending/receiving method according to claim 1, wherein
the transmission path has a wired section and a wireless section;
at least one of the intermediate nodes is a gateway which connects the wired section and the wireless section; and
the transmission rate from the sending terminal is determined in accordance with a state of the receiving and/or sending of data at intermediate nodes including the gateway.

5. The data sending/receiving method according to claim 4, wherein the transmission rate from the sending terminal is determined in accordance with at least one of a round trip time, a fluctuation in the round trip time, and packet loss, excluding the influence of the wireless section.

6. The data sending/receiving method according to claim 1, wherein the bandwidths of all or a portion of the links on the transmission path are measured before data is sent.

7. The data sending/receiving method according to claim 1, wherein a bandwidth of a link with a smallest transmission bandwidth on the transmission path is taken as an initial value of the transmission rate of data sent to the receiving terminal by the sending terminal.

8. The data sending/receiving method according to claim 1,
wherein a transmission bandwidth usable by the intermediate nodes is reserved; and
wherein the transmission rate is determined in accordance with the reserved transmission bandwidth.

9. The data sending/receiving method according to claim 8, wherein the transmission bandwidth usable for the receiving and/or sending of data by the intermediate nodes is based on the type of data to be received and/or sent by the intermediate nodes.

10. A data sending/receiving method, comprising:
a step in which, if congestion has occurred at an intermediate node, the intermediate node adds congestion information indicating that congestion has occurred to data and sends the data to a receiving terminal;
a step in which the receiving terminal determines a transmission rate in accordance with the congestion information and requests a sending terminal to change the transmission rate; and
a step in which the sending terminal changes the data transmission rate in accordance with the request.

11. A data sending/receiving method, in which a plurality of bandwidth estimation packets are sent at a specific interval from a sending terminal over a transmission path between the sending terminal and a receiving terminal, and the arrival interval between the packets is measured at the receiving terminal to estimate a maximum usable bandwidth on the transmission path, wherein:
a portion of data packets sent from the sending terminal are used as the bandwidth estimation packets;
information expressing which data packets of the sent data packets were sent for bandwidth estimation is marked in these sent data packets or sent independently to the receiving terminal; and
results of the measurement at the receiving terminal are sent to the sending terminal.

12. A data sending/receiving method, wherein during congestion, packets including information regarding control for sending/receiving of data are sent with higher priority than data packets.

13. A sending device, comprising:
a measurement means for measuring a state of receiving and/or sending of data in all or a portion of intermediate nodes provided on a transmission path between a sending terminal and a receiving terminal; and
a transmission rate determining means for determining the transmission rate from the state of receiving and/or sending.

14. The sending device according to claim 13, wherein the measurement means measures a propagation delay time or a fluctuation in the propagation delay time, between all or said portion of intermediate nodes and the sending terminal.

15. A receiving terminal, comprising:
a means for obtaining a transmission rate that can be sent by a sending terminal;
a means for detecting congestion information added to a data packet;
a means for determining a transmission rate in accordance with the congestion information; and
a means for requesting the sending terminal to change the data transmission rate based on the determined transmission rate.

16. A sending device for realizing any one of the data sending/receiving methods according to claims 1 to 12.

17. A receiving device for realizing any one of the data sending/receiving methods according to claims 1 to 12.

18. A sending/receiving system, comprising:
a sending device for realizing any one of the data sending/receiving methods according to claims 1 to 12; and
a receiving device for realizing any one of the data sending/receiving methods according to claims 1 to 12.

19. A program for realizing any one of the data sending/receiving methods according to claims 1 to 12.
